(19) United States
(12) Patent Application Publication
(10) Pub. No.: US 2025/0100008 A1
(43) Pub. Date: Mar. 27, 2025

(54) NANOPARTICLE FEED SYSTEMS FOR MANUFACTURING FILTER MEDIA

(71) Applicant: DelStar Technologies, Inc., Alpharetta, GA (US)

(72) Inventors: Lenny Pompeo, Alpharetta, GA (US); Andrew G. Platt, Middletown, DE (US)

(21) Appl. No.: 18/891,517

(22) Filed: Sep. 20, 2024

Related U.S. Application Data
(60) Provisional application No. 63/585,697, filed on Sep. 27, 2023.

(51) Int. Cl. B05C 19/06; B01D 39/16; B65D 88/66; B65D 88/68; B65G 19/14; D04H 1/4218; D04H 1/4291; D04H 1/435; D04H 1/4382; D04H 1/56; D04H 3/16; D06M 11/46; D06M 15/333; D06M 23/08; D06M 101/20; D06M 101/32

(52) U.S. Cl. CPC B05C 19/06; B01D 39/1623; B65D 88/66; B65D 88/68; B65G 19/14; D04H 1/4218; D04H 1/4291; D04H 1/435; D04H 1/43828; D04H 1/56; D04H 3/16; D06M 11/46; D06M 15/333; D06M 23/08; B01D 2239/0216; B01D 2239/025; B01D 2239/0258; B01D 2239/0407; B01D 2239/0478; B01D 2239/0618; B01D 2239/0622; B01D 2239/0627; B01D 2239/10; B01D 2239/1258; B65G 2201/042; D06M 2101/20; D06M 2101/32; D06M 2200/00; D10B 2321/021; D10B 2505/04

(57) ABSTRACT

Systems, devices and methods are provided for producing a product comprising a filter media, such as a gas or liquid filter. A feed system for conveying nanoparticles comprises a container for receiving clusters of nanoparticles and one or more vibration elements coupled to the container and configured to pulse the clusters of nanoparticles to convey the clusters of nanoparticles through the container. The feed system further comprises one or more components for converting the clusters of nanoparticles into a group of nanoparticles having a smaller mass or volume than the cluster of nanoparticles. The system both conveys and breaks down the clusters of nanoparticles, allowing them to be transported from the bulk bin to the filter manufacturing apparatus to form a filter media with improved quality and yield and reduced cost and time. In addition, the system is scalable and produces filter media with less variation.

### CROSS-REFERENCE TO RELATED APPLICATIONS

This application claims the benefit of U.S. Provisional Application Ser. No. 63/585,697, filed Sep. 27, 2023, the complete disclosure of which is incorporated herein by reference for all purposes.

### TECHNICAL FIELD

This description generally relates to systems and methods for manufacturing products containing filter media, such as gas or liquid filters, that incorporate nanoparticles within the filter media.

### BACKGROUND

Filter medias are particularly useful for capturing contaminants in filtration devices due to their fine fiber size. The fibers of the filter media are measured in micrometers and can be formed by spun bond, melt blown, electrospinning, or other techniques. The fine fibers capture and trap contaminants in the filter media as the fluid flows through it.

Contaminants have a wide range of sizes. However, contaminants smaller than 1 micron are the most harmful particles for the human body and are relatively difficult to filter. For example, conventional mechanical air filters typically report MERV ratings for fibrous filtration materials of about 8-10. Therefore, these filter media typically do not capture submicron particles, such as viruses and other harmful pathogens.

The filtration industry has focused on two different methods for capturing these submicron particles: electrostatic forces and the utilization of nanoparticles within the filter media. Electrostatic filters are formed by electrostatically charging the fibers within the filter media, using triboelectric methods, corona discharge, hydro charging, electrostatic fiber spinning or other known methods. Electrostatic filters are most effective at capturing submicron particles, reasonably effective at capturing particles size between 1 and 3 micron, and minimally effective at capturing larger particles from 3 to 10 micron. Electrostatic fibers are commonly used in many filtration applications such as face masks and high efficiency filters to filter submicron contaminants, such as viruses and others.

Another method for capturing submicron contaminants is the use of nanoparticles in conjunction with the fibers. Filtration systems may employ filter media including relatively large fibers having a diameter measured in micrometers and comparatively smaller nanoparticles. The nanoparticles increase the surface area of the within the media for capturing particles by reducing the overall fiber size within the media. The nanoparticles also tend to collapse on each other, increasing the packing density within the filter media. It has been shown that even a small amount of nanometer sized fibers formed in a layer on a microfiber material can improve the filtration characteristics of the material.

The most common way to incorporate nanoparticles into filter media is to apply a thin layer of continuous nanofibers by electrospinning onto a fibrous substrate. The nanoparticles typically extend parallel or normal to the face of the bulk filter media layer and provide high efficiency filtering of small particles in addition to the filtering of the larger particles provided by the coarse filter media. For example, U.S. Pat. No. 6,743,273 discloses a filter media wherein a continuous nanofiber layer is deposited on the surface of a substrate. U.S. Pat. No. 10,799,820 also discloses an air filtration media comprising a continuous nanofiber layer on the surface of the filter media.

While existing filter media that incorporate nanoparticles have improved the relative efficiency of these filters, the commercial potential for these filters has been limited in certain applications because the nanoparticles are typically dispersed onto the surface of the filter media. This relatively thin layer of nanoparticles on the surface of the filter provides only limited filtering of particles and has a relatively low dust holding capacity.

While there have been many attempts to incorporate nanomaterials into the filtration media to increase the overall filtration efficiency, these attempts have been limited to so-called “wetlaid” methods. These wetlaid methods involve incorporating shortcut nanofibers into a liquid slurry to separate the entangled nanofibers with the help of surfactants. For example, U.S. Pat. No. 10,252,201 discloses a filter medium made of a mixture of short-cut nanofibers and short-cut coarse fibers formed by a wetlaid method. Similarly, US Patent Application No. 2021/0023813 discloses a method of manufacturing a composite structure consisting of a continuous nonwoven substrate with discontinuous fibers such as carbon nanofibers. This method includes drawing a continuous fiber nonwoven substrate through a slurry of discontinuous fibers in which nanomaterials are embedded into the nonwoven substrate.

While these structures have demonstrated increased efficiency, they suffer from other issues, such as reduced longevity and/or efficiency as the media is subjected to normal use conditions. Moreover, these wetlaid methods have not successfully incorporated nanoparticles uniformly throughout the nonwoven material, which results in clumping of the nanoparticles within the material, thereby further reducing its efficiency and overall dust holding capacity.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems, devices and methods are provided for manufacturing products comprising filter media. The filter media may include a substrate, such as a sheet, layer, film, apertured film, mesh, netting or other media. The substrate comprises fibers and includes nanoparticles incorporated into at least a portion of the substrate.

In one aspect, a feed system for conveying nanoparticles comprises a container for receiving clusters of nanoparticles and one or more components for converting each cluster of nanoparticles into a group of nanoparticles having a smaller mass or volume than the cluster of nanoparticles. The system further comprises a conveyor for advancing the group of nanoparticles and one or more vibration elements for pulsing the nanoparticles.

The vibration elements pulse the nanoparticles to break apart the clusters of nanoparticles within the container into smaller groups or masses of nanoparticles or into individual nanoparticles. This allows the nanoparticles to free themselves from these clusters and fall to the lower end of the container. The smaller groups or masses of nanoparticles are then conveyed through an opening at the lower end of the container to eventually pass into the filter media manufacturing apparatus.

Nanoparticles are essentially weightless and tend to suspend in air, rending it much more difficult to convey them. In addition, the mechanical properties of nanoparticles do not allow them to fall freely in a tank or vessel in order to be conveyed. Instead, the nanoparticles compact against themselves and stick together causing clumps to form over any type of opening. The vibration elements described herein move the nanoparticles from the container to the manufacturing apparatus continuously and efficiently without compressing and compacting the individual nanoparticles together to form a filter media with improved quality and yield and reduced cost and time. In addition, the system is scalable and produces filter media with less variation.

In embodiments, the vibration elements may have an amplitude of about 5 pounds-force to about 500 pounds-force, preferably about 75 pounds-force to about 250 pounds-force, and may oscillate at a frequency of about 2,000 Hz to about 15,000 Hz, preferably about 7,000 Hz to about 11,000 Hz. The vibration elements may be located on the walls of the container and/or the interior of the container. The vibration elements may be powered by any suitable means. In one embodiment, the vibration elements comprise electromechanical devices that are powered by a DC electrical supply. The vibration element converts the electric current into pulses. In another embodiment, the vibration elements are pneumatically driven by compressed air.

In one embodiment, the vibration elements are disposed on the outer walls of the container and are configured to vibrate the walls of the container. This separates the nanoparticles from the container walls and causes them to fall through a lower opening in the container.

In embodiments, the system comprises a bulk bin configured to open, separate and/or break down larger or macro clusters/clumps of nanoparticles into small clusters of nanoparticles. The container comprises a collection vessel located below the opening of the bulk bin for moving the nanoparticles from the bulk bin to an elevator that elevates the nanoparticles and delivers them to the fiber manufacturing apparatus.

In a preferred embodiment, the collection vessel is shaped to control the volumetric or mass flow rate of the nanoparticles therethrough. In one such embodiment, the vessel is substantially funnel-shaped having a lower opening with a smaller cross-sectional area than an upper opening.

In embodiments, the bulk bin comprises one or more rotors disposed within an interior of the bulk bin. The rotors each comprises one or more rotating blades for mechanically separating the clusters of nanofibers into smaller groups or masses of nanofibers or into individual nanoparticles.

In embodiments, the rotors are configured to rotate about an axis transverse to a height of the container such that the blades convey the nanoparticles downwards through the container to the lower vessel and the conveyor. In a preferred embodiment, at least some of the rotors rotate in a clockwise direction and at least some of the rotors rotate in a counterclockwise direction. In certain embodiments, the bulk bin may comprise one or more rows of such rotors. In an exemplary embodiment, the bulk bin comprises a second, lower row of rotors that function to sweep the nanoparticles from the side walls of the bulk bin.

In embodiments, the feed system comprises an elevator coupled to the container for elevating the nanoparticles from a first height of the container to a second height greater than the first height. Nanoparticles are essentially weightless and tend to suspend in air, rending it much more difficult to convey and/or elevate them. In addition, the mechanical properties of nanoparticles do not allow them to fall freely in a tank or vessel in order to be conveyed. Instead, the nanoparticles compact against themselves and stick together causing clumps to form over any type of opening. The elevator described herein both conveys and elevates the nanoparticles from the container or bulk bin to the manufacturing apparatus continuously and efficiently without compressing and compacting the individual nanoparticles together.

In embodiments, the elevator comprises an outer tube having a plurality of discs configured to move through the tube. The discs preferably have an outer diameter sized to allow the discs to move through the tube while inhibiting the amount of space between the inner walls of the tube and the outer surface of the discs. This configuration defines internal compartments between the discs for housing and conveying clusters of nanoparticles.

The discs may be conveyed through the tube in any suitable manner. In one embodiment, the elevator comprises a cable coupled to the discs and a motor or other energy source coupled to the cable to translate the cable and the discs through the tube. In other embodiments, the discs may be moved with pneumatic, electric, magnetic, mechanical, or other suitable energy sources.

The tube preferably comprises one or more openings for allowing the clusters of nanoparticles to enter and exit the compartments between the discs as the discs are moved through the tube. This allows the elevator to transport the clusters of nanoparticles from the container to the dispersion device. At least one of the openings is located above the tube to allow nanoparticles to fall into the compartments and at least one of the openings is located below the tube to allow the nanoparticles to fall out of the compartments. Alternatively, the tube may contain internal sections that are rotatable such that the compartments may be rotated from one orientation to another as the discs are advanced through the tube.

The tube may extend at an angle transverse to a vertical axis of the system to move the nanoparticles from the first height to the second height. In certain embodiments, the tube extends substantially parallel to the vertical axis.

In embodiments, the feed system comprises at least one feed bin or hopper disposed between the elevator and the dispersion device. The feed bin comprises a device for conveying the nanoparticles in a substantially horizontal direction through the feed bin and into the dispersal device. In an exemplary embodiment, the device comprises an auger. The augur functions to further control the flow rate of nanoparticles moving from the feed bin to the filter media manufacturing apparatus.

In embodiments, the feed system comprises a vessel disposed between the conveyer and the feed bin and configured to control the flow rate of nanoparticles entering the feed bin.

This vessel preferably comprises a funnel shape with an upper opening aligned with the conveyor having a larger cross-sectional area than a lower opening aligned with the feed bin.

In embodiments, feed bin comprises one or more mechanisms for controlling the volumetric flow rate of the nanoparticles therethrough. In one embodiment, at least one of these mechanism advances the nanoparticles in a substantially horizontal direction through the feed bin and into the dispersal device. In an exemplary embodiment, the device comprises an auger that includes one or more curved blades that function to redirect the flow of nanoparticles from vertical to horizontal and to control the volumetric flow rate of nanoparticles from the feed bin to the filter media manufacturing apparatus.

In another aspect, a system for manufacturing a filter media is provided. The system comprises a feeder for advancing a substrate comprising fibers from an upstream end to a downstream end. The system further comprises a dispersion device for dispersing the nanoparticles into the substrate to form the filter media and a feed system for conveying nanoparticles to the dispersion device. The feed system includes one or more vibration elements for conveying the clusters of nanoparticles to the dispersion device at a controlled rate of speed.

The feed system is configured to separate and/or break down the clusters of nanoparticles into either smaller masses of nanoparticles or into individual nanoparticles that can be dispersed into the substrate. In addition, the feed system conveys the nanoparticles to the dispersion device at a controller rate of speed or a controlled volumetric flow rate, allowing them to be transported to the filter manufacturing apparatus to form a filter media with improved quality and yield and reduced cost and time. In addition, the system is scalable and produces filter media with less variation.

In embodiments, the feed system convey the nanoparticles at a rate substantially consistent with the rate that the feeder advances the substrate from the upstream end to the downstream end. This ensures that a substantially constant quantity of nanoparticles is dispersed into each portion or subsection of the substrate, allowing the system to manufacture relatively uniform filter medias with less variation from one filter media to the next. The specific rate of dispersion of nanoparticles into the substrate will depend on the desired specifications of the final filter product, such as the preferred mass of nanoparticles dispersed within a volume or square area of filter media. In an exemplary embodiment, the nanoparticles are dispersed into the moving substrate at a rate of about 0.1 grams/m² to about 10 grams/m², although it will be understood that this rate may vary depending on the specifications of the final product.

In another aspect, a filter media is provided that is produced with one of the system(s) described herein.

In another aspect a gas or liquid filter is provided that is produced with one of the system(s) described herein.

In embodiments, the filter media manufacturing apparatus comprises a first device for separating and/or isolating the nanoparticles within a gaseous medium and a second device for combining the nanoparticles with fibers to form a product containing the fibers and the nanoparticles. The nanoparticles may be separated or isolated in any suitable gaseous medium, such as air, helium, nitrogen, oxygen, carbon dioxide and the like and are dispersed into a product, substrate or fiber stream via a gas stream, aerosol, vaporizer, spray or other suitable delivery mechanism.

Separating and/or isolating individual nanoparticles in a gaseous medium and then dispersing them into a substrate allows the nanoparticles to be distributed more uniformly throughout the product. In addition, the nanoparticles may be dispersed or distributed “in depth” into the product. As used herein, the term “in depth” means that the nanoparticles are dispersed beyond a first surface of a substrate, product or other media such that at least some of the nanoparticles are disposed between first and second opposing surfaces in the internal structure of the substrate.

In certain embodiments, the products are filter media and filters, such as air filters, face masks, gas turbine and compressor air intake filters, panel filters and the like. The nanoparticles increase the overall surface area within the filter media, which increases its filtration efficiency and allows for the capture of submicron contaminants without significantly compromising other factors, such as pressure drop (i.e., air flow) through the filter. In addition, the filters produced with the systems and methods described herein are capable of withstanding rigorous conditioning, which allows a filter to achieve the same level of filtration performance throughout the lifetime of the filter.

In one particular aspect, the first device comprises a fiberization device disposed between the feed system and a suitable dispersion device. The term “fiberization” as used herein means converting (e.g., opening up, separating, isolating and/or individualizing) the clusters, clumps or other groups of nanoparticles into individual nanoparticles having at least one dimension less than 1 micron.

In one embodiment, the second device comprises a nozzle or similar device for dispersing the individual nanoparticles onto a first surface of a substrate comprising the fibers such that the nanoparticles penetrate through at least the first surface of the substrate. The nozzle is preferably configured to disperse the nanoparticles in depth within the substrate. In certain embodiments, the nozzle disperses the nanoparticles throughout substantially the entire media from the first surface to the opposing second surface. In other embodiments, the nozzle disperses the nanoparticles through a portion of the media from the first surface to a location between the first and second surfaces. In other embodiments, the nozzle disperses the nanoparticles in a density gradient from the first surface to the opposing second surface of the substrate. The density of the nanoparticles may be greater at either the first or second surfaces.

The second device may further include a source of negative pressure or a vacuum disposed under the substrate opposite the nozzle to increase the penetration depth and uniformity of the nanoparticles. The source of negative pressure may be any suitable suction device that draws the nanoparticles through the substrate, such as a suction pump or the like.

The second device may further comprise a feeder for advancing the substrate from an upstream end to a downstream end. The nozzle is preferably disposed between these two ends to disperse the nanoparticles onto the substrate. In certain embodiments, the feeder may further comprise a support surface extending between two winders for supporting the substrate as it moves downstream through system. In other embodiments, the substrate unwinds directly from an unwinder to a winder without another support surface.

The second device may further include a coating device for dispersing a binding agent onto the fibers in the substrate. The binding agent may comprise variety of conventional materials, including natural-based materials, such as starch, dextrin, guar gum, or the like, or synthetic resins such as EVA, PVA, PVOH, SBR, polyglycolide and the like. In some embodiments, the substrate includes its own binder composition. In these embodiments, the binding agent or binding material may, or may not, be added to the substrate. In one such embodiment, the substrate comprises biocomponent fibers, wherein one of the components comprises an outer sheath at least partially surrounding an inner core.

The coating device may comprise any suitable device that disperses the binding agent throughout the substate. In one embodiment, the coating device comprises a spray device having an outlet adjacent the upstream end of the feeder and the nozzle. The spray coater may be located downstream of the fiberization device so that the binding agent can be sprayed after nanoparticle deposition. In other embodiments, the system may include two spray coaters: one located upstream from the fiberization device and a second spray coater located downstream of the fiberization system to coat the substrate with a secondary binding agent after deposition of the nanoparticles.

The second device may further include a source of negative pressure or a vacuum disposed under the substrate opposite the spray coater to increase the penetration depth and uniformity of the binding agent. The source of negative pressure may be any suitable suction device that draws binding agents through substrate, such as a suction pump or the like.

The second device may further comprise a dryer, such as an IR oven or the like, disposed near the downstream end of the feeder for heating the nanoparticles and the fibers to bond the nanoparticles to the fibers within the substrate.

The fiberization device may comprise a source of gas, such as compressed air or another suitable gas, and a pump for drawing the smaller clusters of nanofibers from the separator through a passage into the device. The source of compressed air provides the motive fluid to circulate the nanofibers throughout the fiberization device and eventually outwards into the nozzle. The pump may comprise any suitable pump, such as a positive-displacement, a centrifugal, an axial-flow and the like. In one embodiment, the pump comprises an eductor configured to generate a sufficient negative pressure to draw the small clusters of nanofibers from the separator and through the passage into the pump.

The system may further include a source of energy, such as a second pump, second eductor or the like, coupled to the first eductor and configured to propel the small clusters of nanofibers from the first eductor against a surface at a sufficient velocity to break up the nanofibers and convert at least some of the small clusters of nanofibers into individual nanoparticles. Applicant has discovered that propelling the nanofibers into a suitable surface at a velocity of about 500 feet/minute (fpm) to about 10,000 fpm, preferably about 2,000 fpm to about 6,000 fpm, is sufficient to break up at least some of these nanofibers into individual nanoparticles.

The surface may by any surface that opposes the flow of the nanofibers through the passage, such as the inner walls of the passage at a junction point, or other change in direction of the inner walls, e.g., a curved surface, a perpendicular surface or the like. Alternatively, the passage may include walls or other surfaces disposed within the passage, or projecting into the passage in the fluid path. In one embodiment, the passage extends into a substantially T-shaped junction that includes two separate passages extending from the junction. The second eductor is configured to propel the nanofibers into the wall of the T-shaped junction at a velocity sufficient to break apart at least some of the nanofibers.

In certain embodiments, the fiberization device further comprises one or more reactors for separating the individual nanoparticles that have already been isolated from the clumps of nanofibers that have not yet been completely broken down. The reactor(s) comprise a housing coupled to the passages and have an internal chamber and a source of negative pressure configured to draw the smaller clusters of nanofibers away from the individual nanoparticles.

In embodiments, the reactor(s) each comprise a rod or tube extending through the internal chamber and one or more inlets located at one end of the internal chamber and substantially surrounding the tube, which in some embodiments may extend substantially through the center of the internal chamber. The inlets are coupled to the passage(s) such that the clusters of nanofibers and the individual nanoparticles are drawn into the chamber through the inlet(s). The central tube comprises an opening at one end opposite the inlet(s). The opening is coupled to an internal channel within the tube and has an outlet coupled to the nozzle or other dispersion device. This allows nanoparticles to pass into the reactor through the inlets and then into the tube and to the dispersion device.

The inlets may be oriented at an angle relative to the central tube such that the nanofibers and nanoparticles enter the internal chamber at a transverse angle relative to the outer surface of the reactor. In a preferred embodiment, at least one or more of the inlets is oriented such that, when the nanofibers and nanoparticles enter the reactor, they are moving in a direction substantially tangential to the central tube. Once they have entered the annular chamber around the tube, the velocity vector (speed and direction) of the nanofibers and the nanoparticles creates a vortex within the reactor that causes them to swirl around the central tube from one end to the other. Since the individual nanoparticles are significantly lighter than the entangled nanofibers that are still clustered together, these individual nanoparticles are drawn into the inlet of the central tube. The vortex within the chamber may also further break down (e.g., open up, separate and/or individualize) the clusters of nanofibers as they pass through reactor.

The reactor may further comprise one or more outlet(s) located on an opposite end of the inlet(s). The larger and heavier clusters of nanofibers that have not yet been broken down are drawn through these outlet(s). Thus, the isolated and individualized nanoparticles are drawn into the nozzle and the clusters of nanofibers are drawn through the outlet. These outlet(s) may be coupled to the first or second pumps, or to additional pumps within the fiberization device that are designed to further break up the clusters of nanofibers and recirculate them back into the reactor(s).

The recitation herein of desirable objects which are met by various embodiments of the present description is not meant to imply or suggest that any or all of these objects are present as essential features, either individually or collectively, in the most general embodiment of the present description or in any of its more specific embodiments.

### BRIEF DESCRIPTION OF THE DRAWINGS

FIG. 1 schematically illustrates a system for manufacturing filter media;

FIG. 2 schematically illustrates a system for breaking down and/or isolating individual nanoparticles and dispersing the nanoparticles onto a substrate;

FIG. 3 illustrates an eductor of the system of FIG. 2;

FIG. 4 illustrates a reactor of the system of FIG. 2;

FIG. 5 illustrates another embodiment of a system for breaking down and/or isolating individual nanoparticles and dispersing the nanoparticles onto a substrate;

FIG. 6 illustrates a system for manufacturing a dual-layer filter media;

FIG. 7 is a schematic view of a feed system for conveying nanoparticles into one of the filter media manufacturing systems described above;

FIG. 8 is a more detailed view of the feed system of FIG. 7;

FIG. 9 is a partial cross-sectional schematic view of a bulk bin for receiving clusters of nanoparticles and introducing the nanoparticles into the feed system of FIGS. 7 and 8;

FIG. 10 is another schematic view of the bulk bin of FIG. 9;

FIG. 11 illustrates rotors within an interior of the bulk bin;

FIG. 12 is an enlarged view of a lower opening of the bulk bin, illustrating a portion of an elevator configured to convey nanoparticles away from the bulk bin and elevate them through the feed system;

FIG. 13 illustrates one portion of the elevator;

FIG. 14 illustrates another portion of the elevator;

FIG. 15 illustrates clusters of nanoparticles within the portion of the elevator shown in FIG. 14;

FIG. 16 illustrates a receiving vessel for conveying the nanoparticles from the elevator to a feed bin;

FIG. 17 is a schematic view of the feed bin;

FIG. 18 is another schematic view of the feed bin;

FIG. 19 illustrates an interior portion of the feed bin;

FIG. 20 is an expanded view of the interior of the feed bin, illustrating an auger for conveying the nanoparticles away from the feed bin;

FIG. 21 illustrates another receiving vessel from conveying the nanoparticles from the feed bin to the fiber manufacturing system;

FIG. 22 illustrates a fine-tuned flow control device for conveying the nanoparticles into a fiber manufacturing apparatus;

FIG. 23 illustrates a vibration element for vibrating one of the receiving vessels to convey nanoparticles therethrough;

FIG. 24 is a side view of a filter media with nanoparticles dispersed into a portion of the material;

FIG. 25 is a side view of a filter media with nanoparticles dispersed throughout the material;

FIG. 26 is a side view of a filter media with nanoparticles dispersed in a gradient through the material;

FIG. 27 illustrates a dual-layer filter media;

FIG. 28 illustrates a filter media with a support layer;

FIG. 29 illustrates a filter media with nanoparticles dispersed through a depth of the material and a scrim layer overlying the nanoparticles; and

FIG. 30 illustrates a dual-layer filter media with nanoparticles dispersed onto inner surfaces of the two layers.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Systems, devices and methods are provided for manufacturing products comprising filter media and filters. Filter media and filters are also provided that are manufactured with the processes and methods described herein. The filter media may include a substrate comprising at least one or more fiber layers, such as a webs, sheets, films, apertured films, meshes, netting or other media. The fiber layer(s) comprises one or more fibers and include nanoparticles incorporated into at least a portion of at least one of the fiber layer(s). The filters may include, but are not limited to gas filters, such as HEPA and/or HVAC filters, liquid filters, gas turbine and compressor air intake filters, panel filters, filter presses, membrane bioreactor membranes, hydrocarbon filters, diesel filters, fuel filters, hydraulic fluid filters, food and beverage filters, semiconductor filters, microfiltration membranes, downstream membrane filtration, pharmaceutical and medical filters, such as CPAP filters, face masks and the like, waste water filters, industrial process and/or municipal filters, gas turbine and compressor air intake filters, panel filters, cartridge filters, bag filters, clean-in-place (CIP) filters, battery separators and the like.

While the following description is primarily presented with respect to filter media and gas or liquid filters, it should be understood that devices and methods disclosed herein may be readily adapted for use in a variety of other applications. For example, the filter media disclosed herein may be useful in household cleaning products, roofing and flooring products, automobile upholstery and headliners, reusable bags, wallcoverings, filtration devices, insulation and the like. In addition, the individual nanoparticles that are isolated and generated in the processes described herein may be utilized in various coatings, composites and/or additives in, for example, polymers, food packaging, flame retardants, fuel cells, batteries, capacitors, nanoceramics, lights, material fabrication, manufacturing methods, reinforcement for composites, cement and other materials, medical diagnostic applications, medical therapeutic devices or therapies, tissue engineering, such as scaffolds for bone or tissue repair, potable waters, industrial process fluids, food and beverage products, pharmaceutical and biological agents, tissue imaging, medical therapy delivery, environmental applications, such as biodegradable compounds and the like.

The nanoparticles preferably have at least one dimension less than 1 micron (i.e., diameter, width, height, or the like depending on the cross-sectional shape of the fiber). In some embodiments, the nanoparticles comprise mini-fibers or nanofibers that have at least one dimension of about 5 microns or greater. For example, a nanofiber having a diameter or width less than a micrometer and a length greater than 1 micrometer is a nanoparticle as used herein. The nanoparticles may have a continuous length, or the nanoparticles may have discrete length, such as 1 to 100,000 microns, preferably between about 100 to 10,000 microns.

In certain embodiments, each individual nanoparticle may be a small particle that ranges between about 1 to about 1000 nanometers in size, preferably between about 1 to about 650 nanometers. The particle size of at least half of the particles in the number size distribution may measure 100 nanometers or below. The majority of the nanoparticles will typically be made up of only a few hundred atoms. The material properties change as the size of the nanoparticles approaches the atomic scale. This is due to the surface area to volume ratio increasing, resulting in the material's surface atoms dominating the material performance. Owing to their very small size, nanoparticles have a very large surface area to volume ratio when compared to bulk material, such as powders, plate, sheet or larger fibers. This feature enables nanoparticles to possess unexpected optical, physical and chemical properties, as they are small enough to confine their electrons and produce quantum effects.

The substrate may comprise a structure of individual fibers or threads which are interlaid, interlocked or bonded together. For example nonwoven fabrics may include sheets or web structures bonded together by entangling fiber or filaments (and by perforating films) mechanically, thermally, or chemically. They may be substantially flat, porous sheets that are made directly from separate fibers or from molten plastic or plastic film. Examples of suitable nonwoven materials include, but are not limited to, fibers, layers or webs that are meltblown, spunbond or spunlace, heat-bonded, bonded carded, air-laid, wet-laid, co-formed, needlepunched, stitched, hydraulically entangled, thermally bonded or the like.

In certain embodiments, the substrate may comprise a knitted and/or woven material. The knitted material may comprise any knitting pattern suitable for the desired application. Suitable knitted materials for filter applications include weft-knit, warp knit, knitted mesh panels, compressed knitted mesh and the like. Suitable woven materials for filter applications include textile filter media, such as monofilament fabrics, multifilament fabrics, nylon mesh, polyester mesh, polypropylene mesh and the like. Woven textiles may be used in, for example, mesh filter press cloths, woven filter pads and other die cut pieces, centrifuge filter bags, liquid filter bags, dust collector bags, bed dryer bags, rotary drum filters, filter belts, leaf filters, roll media and the like.

In some embodiments, the filter media may include a structure comprising shortcut fibers and/or filaments that are intermingled or entangled. A shortcut fiber as used herein means a fiber of finite length. A filament as used herein means a fiber having a substantially continuous length. In some embodiments, the substrate may comprise shortcut coarse, microfibers and/or fine fibers. As used here in a “fine fiber” means fibers having diameter less than 1 micron, a “coarse fiber” means fibers having diameter more than 10 micron, and a microfiber is a synthetic fiber having a diameter of less than 10 microns.

In certain embodiments, the nanoparticles are dispersed “in depth” within the substrate. As used herein, the term “in depth” means that the nanoparticles are dispersed beyond a first surface of the fiber layer such that at least some of the nanoparticles are disposed between first and second opposing surfaces into the internal structure of the filter media. In certain embodiments, the nanoparticles are dispersed throughout substantially the entire media from the first surface to the opposing second surface. In other embodiments, the nanoparticles are dispersed through a portion of the media from the first surface to a location between the first and second surfaces.

In some embodiments, the nanoparticles are distributed three-dimensionally in space relative to the supporting fiber, which may increase fiber surface area and micro-volumes within the filter media. The three-dimensional distribution also provides resistance against complete blockage of a particular portion of the filter media, which is particularly useful in filter media as it allows fluid (e.g., air and other gases) to pass through the filter, thereby reducing the overall pressure drop across the filter.

In other embodiments, the nanoparticles are disposed in a density gradient across the thickness of the fiber layer such that a higher density of nanoparticles is disposed near one surface than the opposite surface, or a higher density of nanoparticles is disposed on the surfaces as compares to the middle section of the fiber layer. The density gradient may be substantially linear, it may reduce in a series of discrete steps, or the gradient may be random (i.e., a generally reduction in density that is not linear or stepped). This density gradient provides a number of advantageous features for certain applications, such as filters (as discussed below).

The nanoparticles may comprise any suitable material, such as glass, biosoluble glass, ceramic materials, acrylic, carbon, metal, such as alumina, polymers, such as polyethylene, high density polyethylene (HDPE) low density polyethylene (LDPE) nylon, polyethylene terephalate, polypropylene (PP), polybutylene (PBT), ethylene polyester (PET), polylactic acid (PLA), polyamide (PA), polyvinyl chloride (PVC), polyolefin, polyacetal, polyester, cellulous ether, polyalkylene sulfide, poly (arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In some embodiments, nanoparticles may be produced as bicomponent segmented pic and islands in the sea. Then filaments are drawn so much so that submicron filaments are obtained. Continuous filament nanoparticles are cut according to desired length, preferably between about 100 to about 10000 microns.

In some embodiments, nanoparticles are absorbents and adsorbents. In some embodiments, nanoparticles are activated carbon fibers or activated carbon powders. In some embodiments, nanoparticles are catalytic particles or catalytic fibers. In some embodiments, nanoparticles can be obtained by feeding a submicron fiber fibrous in a shredder or a crusher or edge trimmer machine where bonded fibrous gets in and shortcut fiber comes out. For instance, low weight biocomponent meltblown or nano meltblown fabric can be fed into a shredder and submicron nanoparticles can be obtained.

In some embodiments, different nanoparticles may be mixed. For examples, nanoparticles and nanobeads can be mixed. Two different nanoparticles with different melting points can also be mixed so that lower melting point nanoparticle can act as binder for higher melting point nanoparticles. Nanoparticles with different diameters and different lengths can be mixed as well.

In some embodiments, nanoparticles are chosen from environmentally sustainable raw materials. Nanoparticles may compromise bio soluble glass nanoparticles, biodegradable nanoparticles, compostable nanoparticles, or recyclable compositions.

Nanoparticles of different types can be combined. Some of the nanoparticles can be functional nanoparticles. For example, the functional nanoparticles may include activated carbon and/or antimicrobial material deposited onto and/or attached to the fibers in the filter media. This may improve the gas absorption efficiency of the fibers and the effectiveness of killing bacteria. In addition, a fibrous product of a microfiber fibrous with nanoparticles of glass and carbon deposited into it would provide filtration and odor-removing functionality as a filter medium.

In some embodiments, the nanoparticles are bonded to the fibers via mechanical entanglement. This mechanical bond can be supplemented with an adhesive or binding agent, as discussed in more detail below. In certain embodiments, the nanoparticles are not crimped, i.e., they do not include significant wavy, bent, curled, coiled sawtooth or similar shape associated with the nanoparticle in a relaxed state. In other embodiments, the nanoparticles may have a crimped body structure with a discrete length. For instance, when these crimped nanoparticles having a discrete length are attached to the fiber, they entangle among themselves and also with, onto, and around, the fiber with a firm attachment to form a modified fiber. In other embodiments, the attachment of the nanoparticles to the micron fibers is accomplished via electrostatic charge attraction and/or Van der Waals force attraction between the fibers and the nanoparticles.

Filters, such as gas and/or liquid filters also provided that include nanoparticles dispersed in depth within the filter. In some embodiments, the filters include one or more support layers bonded to the filter media. The support layers and/or the filter media may include nanoparticles dispersed in depth within the layer(s). In some embodiments, polymer layers, membranes or films are provided that include one or more apertures for flow of gas or liquid therethrough with nanoparticles disposed in depth within the polymer layer. In other embodiments, the filter media comprises a flexible surface layer for a finger bandage pad, a face mask or the like.

Systems, devices and methods are provided herein for producing the filter media and the products containing the filter media (e.g., gas or liquid filters). Systems and methods are also provided for isolating the individual nanoparticles in a gaseous medium, such as air, helium, nitrogen, oxygen, carbon dioxide and the like (instead of a liquid) and are capable of being dispersed into another product, film, layer or substrate via a gas stream, aerosol, vaporizer, spray or other suitable delivery mechanism.

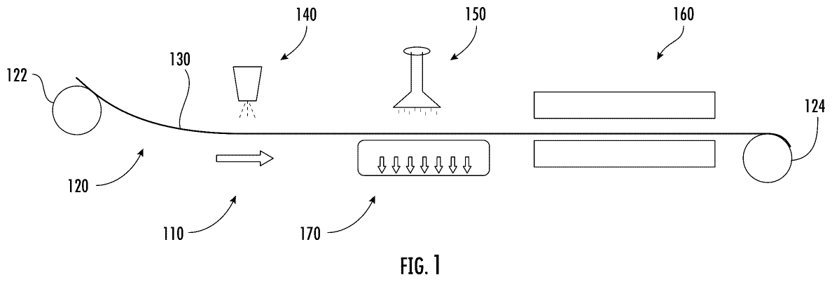

FIG. 1 schematically depicts an overall system 110 for manufacturing the filter medias and other products described herein. As shown, system 110 comprises a feeder 120 for advancing a layer 130 of fibers or other material through the manufacturing process. System 100 further includes a coater 140, a nanoparticle dispersal system 150 and a heating and/or drying device 160. In certain embodiments, system 100 further includes a vacuum or other source of negative pressure 170 underlying substrate 130 opposite fiberization system 150.

In one embodiment, feeder 120 comprises a winder 122 on the downstream end of the process and an unwinder 124 on the upstream end that continuously winds fiber layer 130 through system 100. In certain embodiments, feeder 120 may further comprise a support surface (not shown) extending between the winders for supporting fiber layer 130 as it moves downstream through system 100. In other embodiments, the fiber layer unwinds directly from unwinder 124 to winder 122 without another support surface.

Coater 140 is configured to spray droplets of a binding agent or binding material, such as an adhesive or binder, onto fiber layer 130 so that the nanoparticles can adhere to fibers within layer 130 to form a stable matrix. The binding agent is preferably present in relatively small amounts to bond the individual nanoparticles to fibers throughout layer 130. In a preferred embodiment, coater 140 comprises a spray nozzle sized to generate adhesive droplets having a diameter of about 20 to 30 microns to increase the penetration depth of the adhesive through layer 130. Of course, the droplet size may be affected by numerous other parameters, including air pressure, volume of air, temperature of air, humidity, spray horn design, rheology/viscosity of the adhesive, the carrier and the like.

Of course, it will be recognized that coating the substrate with a binding agent or binding material may be achieved with other coating methods, which include ultrasonic spraying, dip coating, spin coating, gravure coating, kiss roll coating, screen coating, powder coating, electrostatic, sputter coating, or similar coating techniques.

The binding agent may comprise variety of conventional materials, including natural-based materials, such as starch, dextrin, guar gum, or the like, or synthetic resins such as EVA, PVA, PVOH, SBR and the like. In certain embodiments, solvent-based adhesives are used in which bonding occurs upon solvent evaporation.

In one preferred embodiment, the binding agent comprises a dextrin. In another embodiment, the binding agent comprises a composition of various substances, such as water, 2-hexoxyethanol, isopropanol amine, sodium dodecylbenzene sulfonate, lauramine oxide and ammonium hydroxide. In yet another embodiment, the binding agent comprises PVOH.

Binding agents could be in solution, emulsion, suspension, hot melt, curable, neat, and/or a combination.

In some embodiments, an adhesive resin is used and the adhesive resin may undergo cross-linking after the coating of the adhesive on fiber layer 130. Adhesion (water/solvent resistance) may be promoted by self-crosslinking as the solvent in the adhesive formulation evaporates or by heat activation during drying process. In the case of certain adhesives, crosslinking can be accomplished through high energy wavelengths of electromagnetic radiation including, but not limited to. RF, UV, or e-beam. The amount of adhesive can be controlled by adjusting the nozzle size of spray coater 140 or controlling the flow rate of the adhesive composition.

In some embodiments, the binding agent may include a surfactant to lower the surface or interfacial tension of the binding agent, thereby increasing its dispersion and wetting properties and allowing the binding agent to more easily penetrate into the depth of the substrate. Suitable surfactants for use with the binding agents disclosed herein include nonionic, anionic, cationic and amphoteric surfactants, such as sodium stearate, 4-(5-dodecyl)benzenesulfonate, sodium dodecylbenzene sulfonate wetting agents, docusate (dioctyl sodium sulfosuccinate), alkyl ether phosphates, benzalkonium chloride (BAC), perfluorooctanesulfonate (PFOS) and the like.

In some embodiments, spray coater 140 is located upstream of nanoparticle dispersal system 150 so that the binding agent is sprayed before the nanoparticles are deposited. In other embodiments, spray coater 140 is located downstream of system 150 so that the binding agent can be sprayed after nanoparticle deposition. In other embodiments, systems 100 includes two spray coatings; one located upstream from system 150 and a second spray coater (not shown) located downstream of system 150 to coat fiber layer 130 with a secondary binding agent after deposition of the nanoparticles.

In some embodiments, there is more than one nozzle head with each spray coater 140. The nozzle heads may, for example, be disposed in series for better uniformity or to increase fiber spraying width. Alternatively, the nozzle heads may be located in parallel, i.e., across the width of the substrate, to ensure that the binding agent is coated throughout the width of the substrate.

In a preferred embodiment, a source of negative pressure or a vacuum (not shown) is disposed under fiber layer 130 opposite spray coater 140 to increase the penetration depth and uniformity of the binding agent. The source of negative pressure may be any suitable suction device that draws binding agents through substrate, such as a suction pump or the like.

In some embodiments, the fiber layer includes its own binder composition. In these embodiments, the binding agent may, or may not, be added to the fiber layer. In one such embodiment, the fiber layer comprises biocomponent fibers, wherein one of the components comprises an outer sheath at least partially surrounding an inner core. In certain embodiments, sheath and core may be substantially co-centric with each other. In other embodiments, the core may be eccentric with the sheath. In other embodiments, the core and sheath may lie side-by-side with each other. Of course, other configurations are possible. For example, the core may comprise shapes other than circular, such as dog-bone shaped, square, triangular, diamond or the like. Alternatively, the fiber may comprise multiple cores, or it may be split into three, four or more quadrants.

The sheath may comprise a material that bonds to the nanoparticles. For example, the sheath may comprise a material that becomes tacky and/or fluid upon heating and/or drying. During the heating/drying step, the sheath part of the fiber is heated up to its melting point until it becomes tacky and/or fluid to bond the nanoparticles to the fiber layer. In a preferred embodiment, bonding and drying take place at the same time within drying device 160.

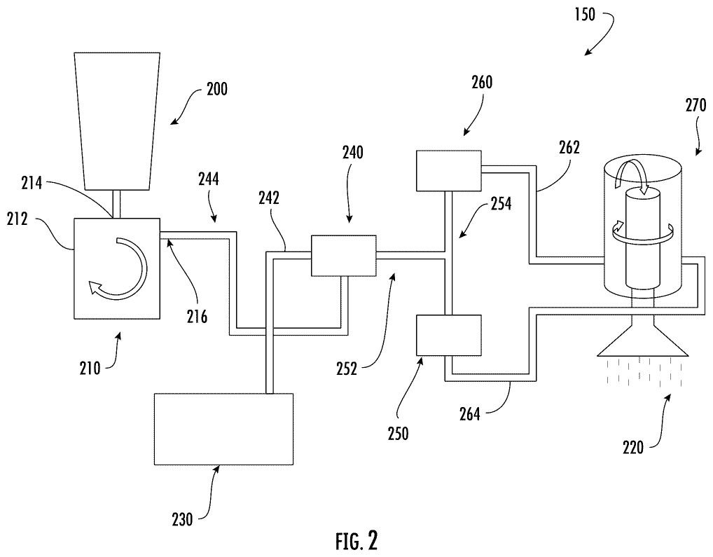

FIG. 2 schematically depicts one embodiment of a nanoparticle dispersal system 150 (or fiberization system) for converting groups of nanoparticles into individual nanoparticles. The term “fiberization” as used herein means converting (e.g., opening up, separating, isolating and/or individualizing) clusters, clumps or other groups of nanoparticles that may, or may not, be entangled with each other into individual nanoparticles having at least one dimension less than 1 micron. Dispersal system 150 coverts macro clusters of entangled nanoparticles into smaller clusters of entangled nanoparticles and then into individual nanoparticles.

As shown, system 150 includes a feeder 200, such a hopper, for introducing the larger or macro clusters/clumps of nanoparticles into system 150. Feeder 200 may comprise any suitable hopper device known by those skilled in the art and preferably is configured to introduce macro clusters of particles into the process at a specified rate, which will depend on the rate of fiberization downstream. The nanoparticles may be introduced continuously at a specified rate, or an intervals at a specific rate. The macro clusters of nanoparticles in bundles may be broken apart prior to introducing them into feeder 200.

It should be recognized that the nanoparticles may be introduced into system 150 in many different forms. For example, raw nanoparticles may be produced as long separated fibers. In this form, the nanoparticles may be cut to obtain the desired length to diameter ratio.

System 150 further includes a separator 210, such as a blender or the like, for separating or breaking down the macro clusters/clumps of nanoparticles into smaller clusters/clumps of nanoparticles. Feeder 200 transfers nanoparticles into separator 210 by any mechanical means in a steady continuous state. The speed of transfer will depend on a variety of factors, such as the velocity of substrate 130 along feeder 120, the rate of fiberization of the nanoparticles and the like. With the help of controlling the amount of nanoparticles dropping into separator 210, the amount of nanoparticles dispersed into the substrate can be controlled to create a continuous manufacturing process.

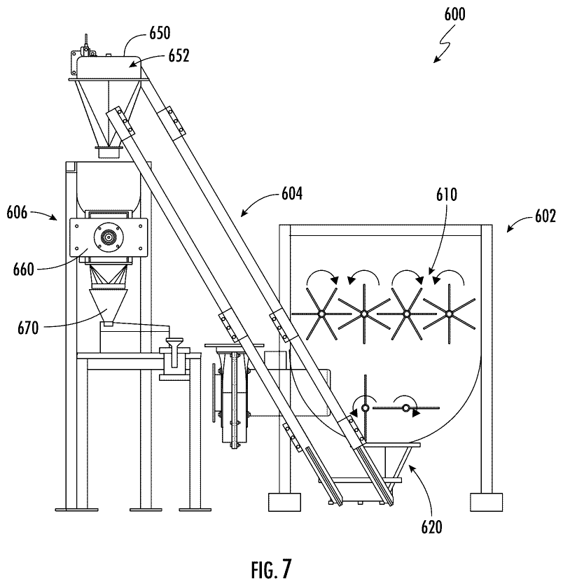

In one embodiment, separator 210 includes a housing 212 with a first opening 214 coupled to feeder 200 and a second opening 216 coupled to the downstream process. The second opening 216 is preferably sized to only allow clusters of nanoparticles having a certain size to pass therethrough. Separator 210 may include a plurality of rotatable blades (not shown) designed to rotate around a vertical axis within housing 212 to separate and open the coarse clusters of nanoparticles. The blades may have the same, or different, pitches and cambers to allow for sequential breaking down or “opening” of the entangled fibers as they pass from first opening 214 to second opening 216. One embodiment of a feeder 200 and separator 210 for a continuous manufacturing process is described below in FIGS. 7-13.

System 150 further includes a stream of gas that extends throughout the system from separator 210 to a nozzle 220 (discussed in more detail below). The stream of gas (along with a series of pumps as discussed below) provides the motive force to move the nanoparticles through system 150. In one embodiment, the stream of gas is created with an air compressor 230 configured to supply compressed air to the system, although it will be recognized that other forms of gas may be used to transfer the nanoparticles through system 150.

System 150 comprises one or more pumps for moving the clusters of nanoparticles and eventually the individual nanoparticles throughout the system. Pumps may comprise any suitable pump, such as positive-displacement, centrifugal, axial-flow and the like. In one embodiment, a first pump 240 includes a first inlet fluidly coupled to air compressor 230 by a first passage 242 and a second inlet fluid coupled to separator 210 by a second passage 244. Compressed air is drawn into first pump 240, which creates a negative pressure (e.g., a vacuum) to draw clusters of nanoparticles from separator 210 into pump (discussed in more detail below). System 150 may further include second and third pumps 250, 260 each fluidly coupled to the outlet of first pump 240. In a similar fashion, second and third pumps 250, 260 create negative pressures that draw the clusters of nanoparticles through a third passage 252.

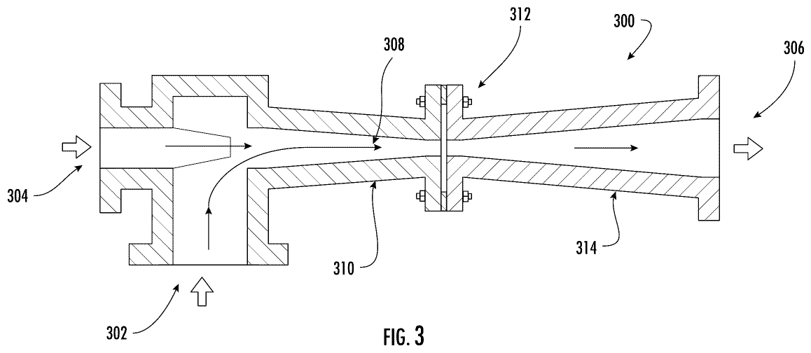

In certain embodiments, pumps 240 comprise eductors 300. As shown in FIG. 3, eductors 300 each comprise a motive fluid inlet 302 and a nanofiber inlet 304 coupled to an outlet 306 via a fluid passage 308. Fluid passage 308 includes a converging inlet nozzle 310, a diffuser throat 312 and a diverging outlet diffuser 314. High-pressure, low-velocity air is converted to low-pressure high-velocity air, thus producing the pressure difference required for suction. Based on the venturi effect and the Bernoulli principle, the primary fluid medium (e.g., compressed air) is used to create a vacuum to draw the nanoparticles into the eductor 300 and to expel them through outlet 306. The diameter of the eductor 300 depends on the volumetric flow rate of the compressed air, the suction requirement, the pressure drop, and the fluid pressure of the compressed air.

Referring back to FIG. 2, third passage 252 includes a junction 254 that splits third passage 252 into two separate passages, each leading to second and third pumps 250, 260. Junction 254 preferably includes a surface or wall that is disposed substantially perpendicular to third passage 252 to form a T-shaped intersection. The surface may by any surface that opposes the flow of the nanoparticles through the passage, such as the inner walls of the passage at a junction point, or other change in direction of the inner walls, e.g., a curved surface, a perpendicular surface or the like. Alternatively, the passage may include walls or other surfaces disposed within passage, or projecting into the passage in the fluid path. In one embodiment, the passage extends into a substantially T-shaped junction that includes two separate passages extending from the junction. The second eductor is configured to draw the nanoparticles into the T-shaped junction at a velocity sufficient to break apart at least some of the nanoparticles.

As the clusters of nanoparticles move through third passage 252, they are propelled against this surface or wall by the negative pressure applied by second and third pumps 250, 260. This velocity of the nanoparticles against junction 254 creates a collision with sufficient kinetic energy to cause at least some of the clusters of nanoparticles to break up into smaller clusters of nanoparticles and/or into individual nanoparticles having at least one dimension less than 1 micron.

In order to create the necessary kinetic energy to break down the clusters of nanoparticles, the air is propelled throughout system 150 at a velocity of about 500 feet/minute (fpm) to about 10,000 feet/minute, preferably about 2,000 fpm to about 6,000 fpm. The system 150 includes a sufficient amount of suction pressure, preferably at least about 20 psi. This suction pressure creates an overall pressure throughout the system of at least about 100 psi.

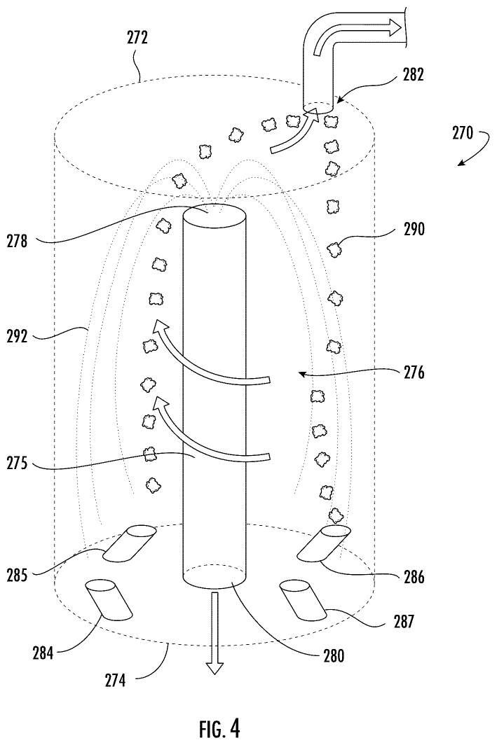

In certain embodiments, system 150 further includes fourth and fifth fluid passages 262, 264 that couple the outlets of second and third pumps 250, 260 with a reactor 270. As shown in FIG. 4, reactor 270 comprises a top surface 272, a bottom surface 274 and an internal annular chamber 276 extending from top surface 272 to bottom surface 274. Reactor 270 further includes a central tube 275 having an open upper inlet 278 and an outlet 280. Reactor 270 may further include one or more upper outlet(s) 282. Reactor 270 may be coupled to a source of energy (not shown) that is configured to create a vortex of swirling gas within annular chamber 276. The source of energy may comprise any suitable energy source, such as a pump, compressor, generator and the like. The swirling gas preferably flows around central tube 275 from the bottom of reactor 270 to the top to move the clusters of nanoparticles and the individual nanoparticles upwards from bottom surface 275 towards top surface 272.

In another embodiment, the vortex is created without a separate source of energy. In this embodiment, the clusters of nanoparticles 290 and individual nanoparticles 292 enter the reactor 270 through bottom inlets 284, 285, 286, 287. Inlets 284, 285, 286, 287 are angled upwards to facilitate movement of the nanoparticles and nanoparticles around central tube 275. In a preferred embodiment, at least one or more of the inlets 284, 285, 286, 287 is angled such that the nanoparticles and nanoparticles enter the reactor 270 such that they are substantially tangential to central tube 275. Once they have entered annular chamber 276, the velocity vector (speed and direction) of the nanoparticles and nanoparticles creates a vortex within reactor 270 that causes them to swirl around central tube 275 and upwards to the upper portion of chamber 276. The swirling gas preferably flows around central tube 275 from the bottom of reactor 270 to the top to move the clusters of nanoparticles and the individual nanoparticles upwards from bottom surface 275 towards top surface 272. Without any interruption, the nanoparticles 290 and nanoparticles 292 are blown from bottom of the reactor to the top. The vortex within chamber 276 may further break down (e.g., open up, separate and/or individualize) the clusters of nanoparticles 290 as they pass through reactor 270.

In some embodiments, reactor 270 may also be coupled to a source of energy (not shown) that is configured to create the vortex of swirling gas within annular chamber 276. The source of energy may comprise any suitable energy source, such as a pump, compressor, generator and the like.

The system 100 may further include another pump or source of negative pressure coupled to upper outlet 282. This negative pressure draws fibers through outlet 282 such that the fibers 290 exit the reactor 270. Since the individual nanoparticles 292 are significantly lighter than the entangled nanoparticles 290 that are still clustered together, these individual nanoparticles 292 are drawn into upper inlet 278 of central tube 275. Meanwhile, the larger and heavier clusters of nanoparticles 290 that have not yet been broken down are drawn through upper outlet 284. Upper outlet 284 may be coupled to other pumps (not shown), or to first pump 240. In this manner, the clusters of nanoparticles 290 are sent through the process again to become further broken down, creating a refeed system to further break down the remaining clusters of nanoparticles.

Outlet 280 of central tube 275 is coupled to nozzle 220 (see FIG. 2). The individual nanoparticles 292 are drawn into nozzle 220, where they are dispersed onto a surface of the substrate or into a fiber stream (discussed below). Nozzle 220 may comprise any suitable nozzle known by those in the art. In one embodiment, nozzle 220 has a plurality of outlets having an outer dimension tailored for the size (i.e., area) of the substrate passing below nozzle 220. The nozzle 220 will disperse the nanoparticles onto the substrate at a rate that is driven by the pressure throughout the system.

In certain embodiments, system 100 comprises more than one nozzle coupled to the outlet 280 of reactor 270. The nozzles may be arranged in any suitable form over the substrate, e.g., side-by side, in series, in parallel, or the like.

It will be recognized that pump 240, or pumps 250, 260 may directly feed the nanofiber/air mixture stream into the nozzle 220 (i.e., bypassing reactor 270). In this embodiment, the pressure within system is designed to create sufficient kinetic energy to break down or open up substantially all of the nanoparticles into individual nanoparticles such that reactor 270 is not required to separate the nanoparticles from the larger clusters of fibers.

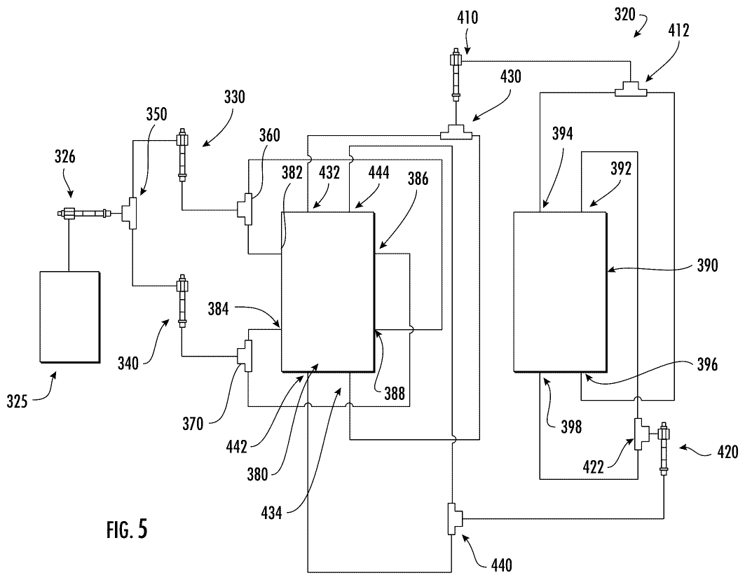

Referring now to FIG. 5, another embodiment of a nanoparticle dispersal system 320 will now be described. As shown, system 320 includes a separator 325 for separating larger or macro clusters of nanoparticles into the smaller clusters of nanoparticles that will pass through system 320. A first eductor 326 is coupled to an outlet of separator 325 and serves to draw the nanoparticles from separator 325 and into system 320. An air compressor (not shown) is also coupled to eductor 326 to provide the motive fluid, as discussed above.

Similar to the previous embodiment, second and third eductors 330, 340 are coupled to an outlet of the first eductor 326. The nanoparticles are drawn through first eductor 320 and propelled against a surface of a T-shaped intersection 350 to break down at least some of the nanoparticles into smaller clusters or individual nanoparticles.

Each of the second and third eductors 330, 340 have outlets coupled to additional T-shaped intersections 360, 370. As before, nanoparticles are propelled against the surface of the T-shaped intersection 360, 370 to further break them down. The T-shaped intersections 360, 370 are each coupled to two fluid passages that enter the bottom portion 380 of a reactor. Thus, bottom portion 380 of reactor has four separate inlets 382, 384, 386, 388 for passage of the nanoparticles. Each of these inlets is preferably angled upwards and positioned in opposite corners of the reactor. This allows the nanoparticles to enter into the vortex of the reactor and then swirl upwards to an upper portion 390 of the reactor.

As discussed previously in reference to FIG. 4, the reactor includes an annular chamber with a central tube having an open upper end and a lower end coupled to a nozzle. The nanoparticles that have been sufficiently broken down into individual nanoparticles flow through this open upper end and into the central tube for dispersion through the nozzle. The heavier clusters of nanoparticles that have not yet been broken down exit the reactor through one of four separate outlets 392, 394, 396, 398. Eductors 410, 420 provide the motive force for drawing the nanoparticles from reactor 400, as discussed above. Outlets 392, 394 are each coupled to eductor 410 via a T-shaped intersection 412 and outlets 396, 398 are each coupled to eductor 420 via a T-shaped intersection 422. In this case, the nanoparticles flow from two passages into one passage as they pass through intersections 412, 422.

Eductors 410, 420 are each coupled to T-shaped intersections 430, 440. As described before, the nanoparticles are propelled into T-shaped intersections 430, 440 to further break them down into individual nanoparticles. T-shaped intersections 430, 440 are then each coupled to the bottom portion 380 of reactor 400 (via inlets 432, 434, 442, 444). This allows the nanoparticles to pass back into reactor 400 for further processing. This process continues for each cluster of nanoparticles until it has been entirely broken down into nanoparticles and passed through the central tube into the nozzle. As a last step, individualized nanoparticles are air sprayed from the nozzle onto any substrate or mixed with any fiber spinning stream. During this process, suction is up to 20 psi, pressure is up to 100 psi.

In certain embodiments, systems 150 or 200 may include a separate control system that monitors the nanoparticles to determine when they have been broken down into individual nanoparticles suitable for passing through nozzle. The control system may, for example, simple monitor the pressure throughout the system to ensure that sufficient pressure is being applied to the nanoparticles to break them down into nanoparticles. Alternatively, this control system may comprise a variety of different sensors disposed through the system to detect characteristics of the nanoparticles, such as weight or size. The sensors may be disposed, for example within reactor 400 such that the control system may control various parameters of reactor 400, such as the negative pressure applied to outlets, 392, 394, 396, 398, the speed of the vortex passing around the annular chamber, or the pressure applied to central tube that draws then nanoparticles into the nozzle.

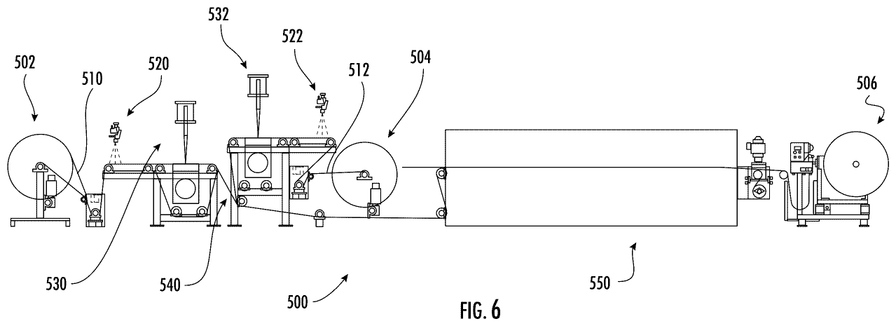

FIG. 6 illustrates another embodiment of a system 500 for manufacturing multiple layers of filter media. As shown, system 500 comprises first and second unwinders 502, 504 and a single winder 506 for winding first and second substrates 510, 512 downstream through system 500. As in previous embodiments, system 500 may further comprise a support surface (not shown) for each of the substrates 510, 512. First and second unwinders 502, 504 serve to advance the first and second substrates 510, 512 into the process, where they are joined together and then wound towards a single winder 506, as discussed below.

System 500 includes first and second spray coaters 520, 522, each positioned downstream of first and second unwinders 502, 504 for applying binding agents to the first and second substrates 510, 512. System 500 further includes first and second fiberization systems/devices 530, 532 positioned downstream of each of the spray guns 520, 522. As discussed previously, fiberization devices 530, 532 generate individual nanoparticles and disperse those nanoparticles onto substrates 510, 512.

Once the nanoparticles have been dispersed into substrates 510, 512, the two substrates are joined together at a junction point 540 such that they are advanced downstream together. The two substrates may be bonded to each other at this point, or they may simply be laid one on top of the other.

The system 500 further includes a heater/drying device, such as an IR oven 550, downstream of the junction point 540 of the two substrates. The heating/drying device heats and dries the two substrates to bond them to each other and to bond the nanoparticles to the fibers within the substrates. The substrates may, for example, be laminated to each other.

In certain embodiments, nanoparticles are dispersed into both of the substrates 510, 512. In one such embodiment, system 500 is designed such that nanoparticles are dispersed through first surfaces of each of the substrates. The substrates can then be joined such that the first surfaces are facing each other. Alternatively, the first surfaces may be facing away from each other (i.e., joining the substrates at the second, opposing surfaces of each substrate). In yet another embodiment, a first surface of the first substrate is joined to a second surface of the second substrate.

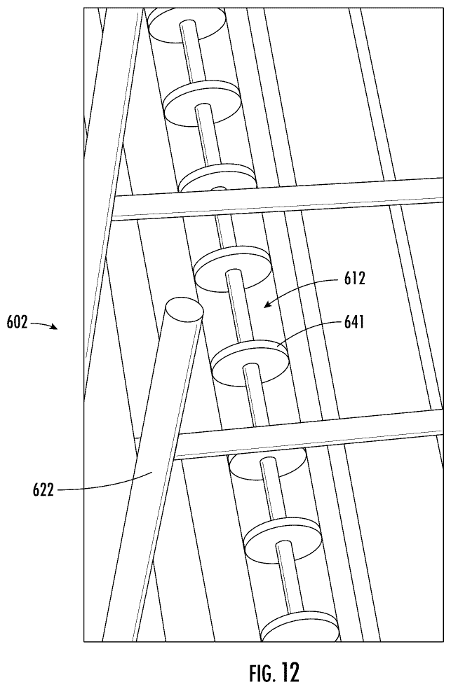

FIGS. 7-22 illustrate one embodiment of a feed system 600 for separating or breaking down larger clusters/clumps of nanoparticles into smaller clusters and/or into individual nanoparticles and then conveying those smaller clusters and/or individual nanoparticles into one of the filter manufacturing systems described above. Feed system 600 is particularly useful for introducing nanoparticles into a continuous manufacturing process at a controlled mass or volumetric flow rate (i.e., the quantity, volume or total mass of nanoparticles that pass through feed system 600 per unit of time). The nanoparticles may be introduced continuously at a specified flow rate, or an intervals at a specific flow rate. The speed of transfer will depend on a variety of factors, such as the velocity of substrate 130 along feeder 120 (see FIG. 1), the rate of fiberization of the nanoparticles, the desired amount of nanoparticles dispersed into a given area/volume of substrate and the like. With the help of controlling the amount, mass or volume of nanoparticles dropping into the manufacturing system, the amount of nanoparticles dispersed into the substrate can be controlled to create a continuous manufacturing process with improved quality and yield and reduced cost and time. In addition, the system is scalable and produces filter media with less variation.

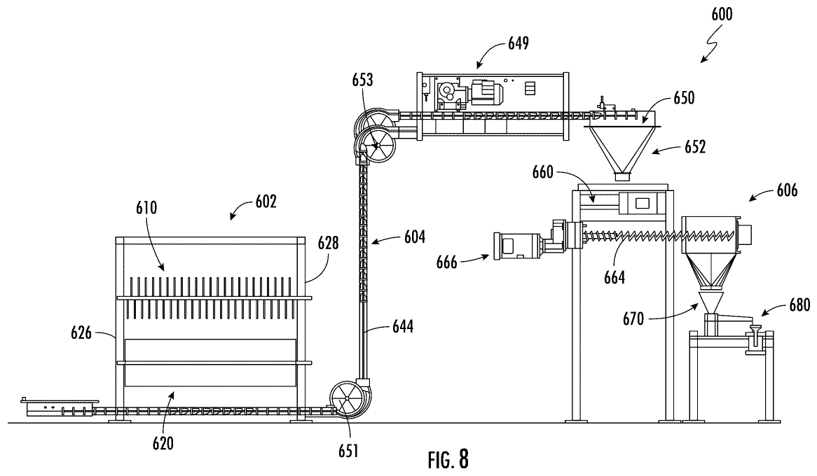

As shown in FIGS. 7 and 8, feed system 600 generally comprises a container or bulk bin 602, such a hopper, for receiving relatively large (i.e., macro) clusters or bundles of nanoparticles and an elevator 604 for elevating the nanoparticles to a dispersal system 606 that disperses the nanoparticles into the filter manufacturing system (discussed above). The macro clusters or bundles of nanoparticles may be partially broken apart prior to introducing them into bulk bin 602, and/or they may be partially or completely broken up and separated within container 602. It should be recognized that the nanoparticles may be introduced into feed system 600 in many different forms. For example, raw nanoparticles may be produced as long separated fibers, such as nanofibers, mini-fibers or the like. In this form, the nanoparticles may be cut to obtain the desired length to diameter ratio.

Bulk bin 602 functions as a separator, such as a blender or the like, for separating or breaking down the macro clusters or bundles of nanoparticles into smaller clusters or masses of nanoparticles or directly into individual nanoparticles. In one embodiment, bulk bin 602 includes a plurality of rotatable screws or rotors 610 designed to rotate around an axis within bulk bin 602 to separate and open the coarse clusters of nanoparticles (see FIGS. 9-12 discussed in more detail below).

As shown in FIGS. 9 and 12, rotors 610 may also function to drive the individual nanoparticles downwards towards an opening 612 at or near the bottom surface of container 602. The individual nanoparticles do not behave in the same manner as macro sized objects. Because the mass of nanoscale objects is so small, the force of gravity has very little effect on the attraction between objects of this size. Thus, gravitational forces may have little to no effect on these particles (i.e., they are not automatically pulled downwards towards opening 612 by gravity). Opening 612 is coupled to a collection vessel 620 (see FIG. 7) for collecting the individual nanoparticles that have been broken up in container 602 and feeding them to elevator 604 (discussed in more detail below).

As shown in FIG. 9, rotors 610 may be driven by an external motor 612. In one embodiment, motor 612 includes a rotatable drive shaft 614 coupled to a cable or pully system 616. Each of the rotors 610 may be formed on a rotatable disc or shaft 618 that is coupled to the pulley system 616 such that rotation of drive shaft 614 causes rotation of the rotors 610. In certain embodiments, a single motor 612 will drive all of the rotors 610. In other embodiments, the system may include multiple motors, with each motor independently driving one or more of the rotors 610. Motor 612 may comprise any suitable motor, such as a brushless DC motor, permanent magnetic DC motor, stepper motor, linear motor, synchronous motor, electromagnetic induction motor, servomotor, PMDC brush motor, shunt motor, series motor, compound motor or the like.

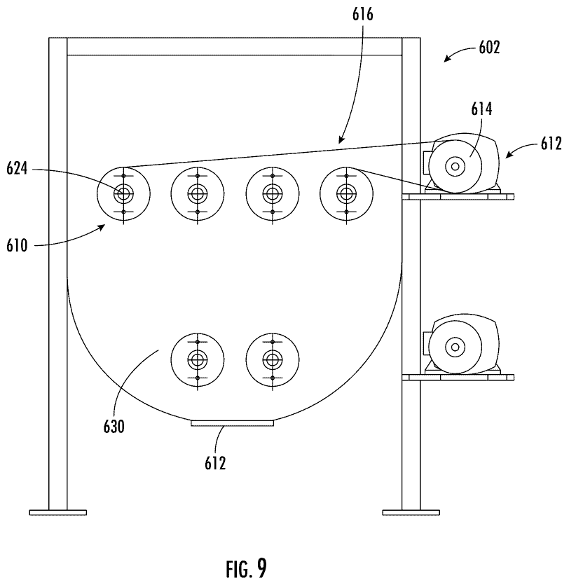

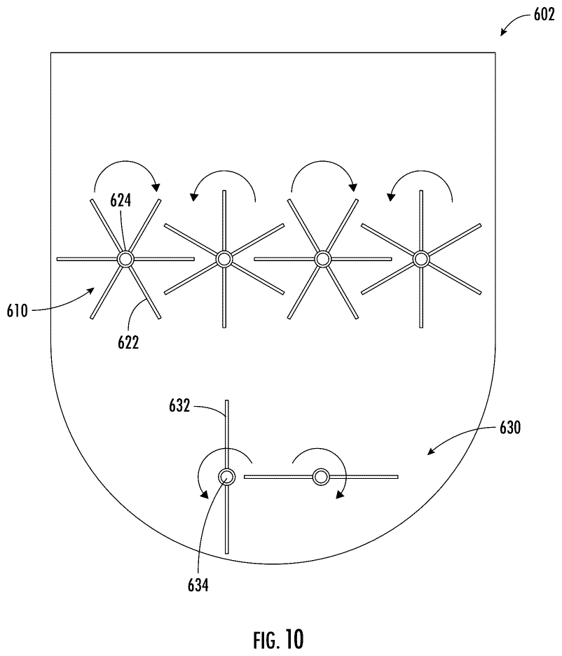

As shown in FIG. 10, rotors 610 each include a plurality of individual blades 622 spaced circumferentially around a central hub 624. In one such embodiment, each hub 624 includes five separate blades 622 spaced uniformly around the hub, although it will be recognized that the blades may include less than 5 individual blades or more than 5 individual blades. Blades 622 may have the same, or different, pitches and cambers to allow for sequential breaking down or “opening” of the entangled fibers as they pass through bulk bin 602.

In an exemplary embodiment, each central hub 624 is positioned such that its blades 622 rotate about an axis transverse to a vertical axis extending through bulk bin 602. In an exemplary embodiment, this axis is substantially perpendicular to the vertical axis of bulk bin 602. Thus, as the clusters of nanoparticles pass downwards through bulk bin 602, blades 622 engage these clusters to separate them or break them down into smaller clusters/clumps of nanoparticles or directly into individual nanoparticles. Blades 622 also function to force or convey the nanoparticles downwards through the bulk bin 602. Bulk bin 602 may include a single row of rotors 610 or multiple rows of rotors 610.

Rotors 610 may be configured to rotate in opposite directions, with some of the hubs 624 rotating counterclockwise and others rotating clockwise. Alternatively, all of the rotors 610 may rotate in the same direction, i.e., counterclockwise or clockwise. In an exemplary embodiment, container 602 includes a row of at least four rotors 610 extending substantially parallel to each other across a horizontal axis of the container 602, with each alternate propeller rotating in an opposite direction from the adjacent propeller, as shown in FIG. 10.

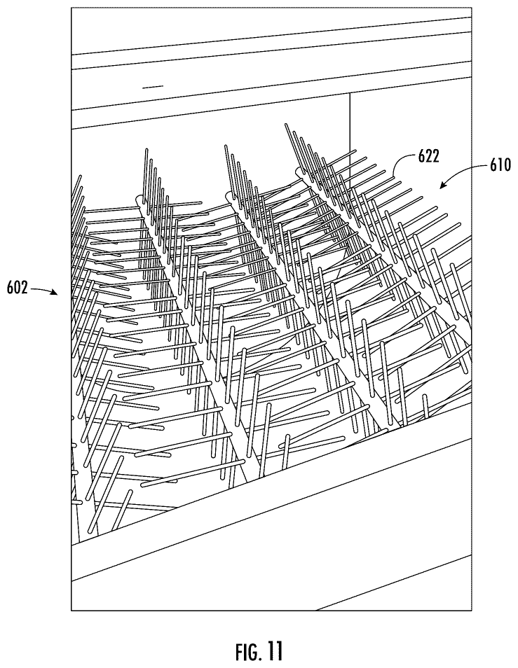

As shown in FIGS. 8 and 11, each central hub 624 of rotors 610 preferably extends from one side 626 of bulk bin 602 to the other side 628 and includes multiple sets of blades 622 extending along its entire length. Each hub 624 may include 2 or more, 5 or more, 10 or more, 20 or more, or 40 or more sets of blades extending along its length depending on the overall dimensions of bulk bin 602. Each set of blades are preferably spaced from each other by a suitable distance that ensures that larger clumps of nanoparticles cannot fall between the sets of blades without contacting the blades.

In certain embodiments, the hubs 624 are staggered (vertically and/or horizontally) from each other along the width and/or depth of bulk bin 602 (see FIG. 11) such that each set of blades 622 covers a different cross-sectional area of the interior of bulk bin 602. In addition, the blades 622 may be designed to overlap with each other such that one set of blades on one hub extends through the gap between two sets of blades of another hub 624. This ensures that clumps of nanoparticles residing between two sets of blades are contacting by the blades of a different hub.

In one embodiment, container 602 includes a lower row of rotors 630 that primarily function to sweep the nanoparticles from the internal walls of bulk bin 602 to drive them into opening 612 (see FIGS. 9 and 10). To that end, rotors 630 preferably comprise at least two rotating blades 632 around a central hub 634. Hubs 634 preferably rotate in opposite directions, with one hub rotating clockwise and the other hub rotating counterclockwise such that the rotors 630 may sweep nanoparticles clinging to either side of container 602. Hubs 634 preferably extend along an axis substantially perpendicular to the vertical axis of container 602, although it will be recognized that other embodiments have been considered. For example, bulk bin 602 may include a plurality of rotors 630 positioned along the internal walls of bulk bin 602 to sweep nanoparticles from these walls and drive them towards opening 612.

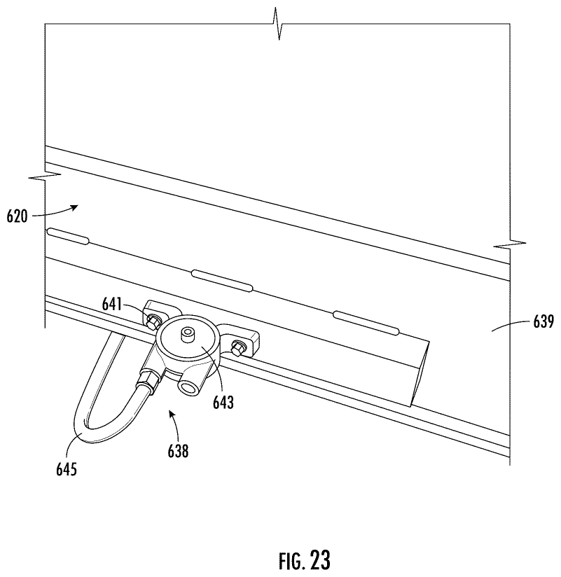

As shown in FIG. 7, collection vessel 620 has an upper opening coupled to bulk bin 602 and a lower opening coupled to elevator 604. The lower opening has a substantially smaller cross-sectional area than the upper opening such that the nanoparticles are “funneled” downwards to control the flow rate of the nanoparticles through the system, as discussed in more detail below. In addition, vessel 620 includes one or more mechanisms for conveying or driving the nanoparticles therethrough. In one embodiment, at least one of these mechanisms includes one or more vibration elements 638 (see FIG. 23) coupled to vessel 620 that function to convey the nanoparticles through vessel 620 and into elevator 604. The vibration elements also function to pulse the nanoparticles to break apart those nanoparticles that tend to stick in clumps within vessel 620. This allows the nanoparticles to free themselves from these clumps and fall into elevator 604.

The vibration elements may have an amplitude of about 5 pounds-force to about 500 pounds-force, preferably about 75 pounds-force to about 250 pounds-force, and may oscillate at a frequency of about 2,000 Hz to about 15,000 Hz, preferably about 7,000 Hz to about 11,000 Hz. The vibration elements may be located on the walls and/or the interior of vessel 620. The vibration elements may be powered by any suitable means. In one embodiment, the vibration elements comprise electromechanical devices that are powered by a DC electrical supply. The vibration element converts the electric current into pulses. In another embodiment, the vibration elements are pneumatically driven by compressed air.

Referring now to FIG. 23, vibration elements 638 may be coupled to one or more of the outer walls 639 of collection vessel 620 (or any of the other vessels within feed system 600). In one embodiment, vibration elements 638 each comprise one or more attachment elements 641 for attaching an oscillator 643 to outer walls 639 and a connection element 645 for coupling vibration element 638 to a suitable power source. Vibration elements 638 are configured to vibrate the outer walls 639 of collection vessel to pulse the nanoparticles and break apart those nanoparticles that tend to stick in clumps within vessel 620. This allows the nanoparticles to free themselves from these clumps and fall into elevator 204.

Referring now to FIGS. 8, and 13-15, elevator 604 functions to elevate the nanoparticles exiting vessel 620 from a first height to a second height greater than the first height. Nanoparticles generally do not convey because they have little to no weight. As a consequence, the nanoparticles tend to compact against themselves, sticking together in clumps that form over any type of opening. Elevator 604 overcomes these issues by both conveying and elevating the nanoparticles from vessel 620 to dispersal system 606.

In certain embodiments, elevator 604 comprises one or more transport tube(s) 640 that function to convey the nanoparticles to a higher elevation without compressing them back into clumps. In certain embodiments, tube 640 includes at least one section that extends at a transverse angle to the vertical (see FIG. 7). In other embodiments, tube 640 includes at least one section that is substantially parallel to vertical (see FIG. 8). Elevator 604 comprises a plurality of discs 641 that are spaced from each other throughout tube 640. Discs 641 generally have a diameter sized to allow discs 641 to pass through tube 640 (i.e., slightly less than the inner diameter of tube 640). In addition, the diameter of discs 641 are close enough to the inner diameter of tube 640 to define interior compartments 642 between adjacent discs 641. The discs 641 function to isolate the interior of the compartments 642 as each compartment 642 is conveyed through tube 640.

Tube 640 extends from a lower opening (not shown) in collection vessel 620 to an upper opening 650 of a funnel-shaped conveyance vessel 652 in dispersal device 606. For reasons discussed below, vessel 652 is located above vessel 620 and, therefore, tubes 640 convey and elevate the nanoparticles from a first height to a second height greater than the first height.

Elevator 604 further includes a cable 644 within tube 640 that conveys the compartments 642 through the tube 640. In one embodiment, cable 644 extends through each disc 641 within tube 640 and is coupled to a suitable source of energy for moving cable 644 (and discs 641 therewith) through the tube. Tube 640 may extend upwards from vessel 620 to dispersal device 606 and then back downwards to vessel 620 (see FIG. 7). The compartments 642 moving upwards generally contain the nanoparticles and the compartments 642 moving downwards are substantially empty of nanoparticles. Alternatively, tube 640 may be a continuous tube that moves in one direction.

Referring again to FIG. 8, elevator 604 preferably comprises a motor 649 coupled to cable 644 for propelling cable 644 in one direction through feed system 600 such that discs 641 are propelled in that direction. Motor 649 may comprise any suitable motor, such as a brushless DC motor, permanent magnetic DC motor, stepper motor, linear motor, synchronous motor, electromagnetic induction motor, servomotor, PMDC brush motor, shunt motor, series motor, compound motor or the like.

Cable 644 may be coupled to one or more drive wheels that redirect cable 644 through feed system 600. For example, as shown in FIG. 8, cable 644 preferably extends substantially horizontally underneath bulk bin 602 and then is redirected into a vertical direction by a first drive wheel 651 to elevate the clumps of nanoparticles. A second drive wheel 653 functions to redirect the cable 604 to a substantially horizontal direction where it passes over vessel 652 to distribute the nanoparticles into dispersal system 606.

Tube 640 comprises one or more openings (not shown) that are aligned with the openings in vessel 620 and vessel 652 to allow the nanoparticles to enter compartments 642 from vessel 620 and to exit compartments 642 into vessel 652. In certain embodiments, the opening(s) located adjacent vessel 620 are on an upper surface of tube 640 and the opening(s) located adjacent vessel 652 are on a lower surface of tube 640. Alternatively, tube 640 may have rotatable sections that allow the openings to move from one configuration to another. Thus, as an individual compartment 642 passes by the opening underlying vessel 620, nanoparticles may fall into compartment 642 from vessel 620. As the compartment 642 continues to move upwards along tubes 642, the inner walls of tubes 642 and the discs 641 of compartments 642 will enclose the interior of compartment 642 such that the nanoparticles are trapped therein. This allows the nanoparticles to be conveyed along tubes without compressing them into bundles or clumps.

Alternatively, the openings in the tube 640 may be capable of opening and closing. For example, elevator 604 may include one or more actuators that function to open and close these openings in tubes 640. The actuators may comprise any suitable mechanisms, such as electronic actuators, pneumatic actuators, mechanical actuators or the like. In certain embodiments, system 600 further includes a controller (not shown) that functions to automatically open and close these openings at the appropriate times, or based on data obtained from sensors (i.e., opening when they pass underneath vessel 620 and then closing them as they move upwards towards dispersal device 606). In other embodiments, system 600 may mechanical elements that cooperate with each other to automatically open and/or close the openings at they pass by vessel 620 and dispersal device 606.

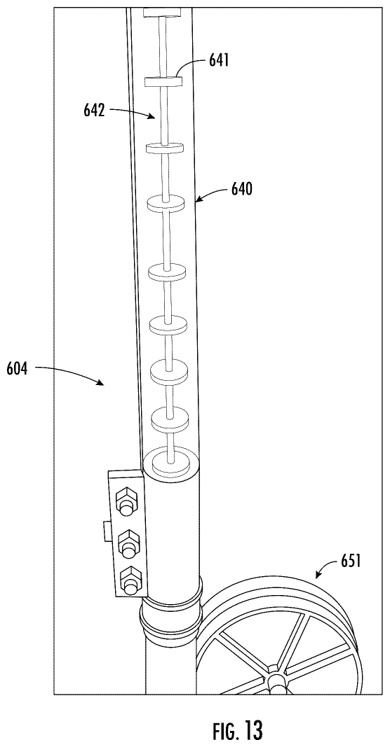

FIG. 15 illustrates clusters of nanoparticles 647 being moved by elevator 604. As shown, each clump of nanoparticles 647 resides within the compartment 642 between two discs 641 within tubes 640 of elevator 604. As the discs 641 are propelled through tube 640, the clumps of nanoparticles 647 are propelled therewith.

Referring back to FIG. 8, dispersal system 606 functions to control the speed of conveyance or flow rate of nanoparticles passing into the filter media manufacturing system. In particular, dispersal system 606 ensures that an appropriate amount of nanoparticles are dispersed onto the fibers within the substrate. For example, dispersal system 606 is configured to convey the nanoparticles at a specified mass or volumetric flow rate that is substantially consistent with the rate that the feeder 200 advances the substrate from the upstream end to the downstream end. This ensures that a substantially constant quantity of nanoparticles is dispersed into each portion or subsection of the substrate, allowing the system to manufacture relatively uniform filter medias with less variation from one filter media to the next. The specific rate of dispersion of nanoparticles into the substrate will depend on the desired specifications of the final filter product, such as the preferred mass of nanoparticles dispersed within a volume or square area of filter media. In an exemplary embodiment, the nanoparticles are dispersed into the moving substrate at a rate of about 0.1 grams/m² to about 10 grams/m² although it will be understood that this rate may vary depending on the specifications of the final product.

The rate of advancement of the substrate will depend on many factors in the production process, including the desired amount of nanoparticles dispersed into each section of the substrate. In one embodiment, the rate of advancement of the substrate is about 0.05 to about 1 meters/second.

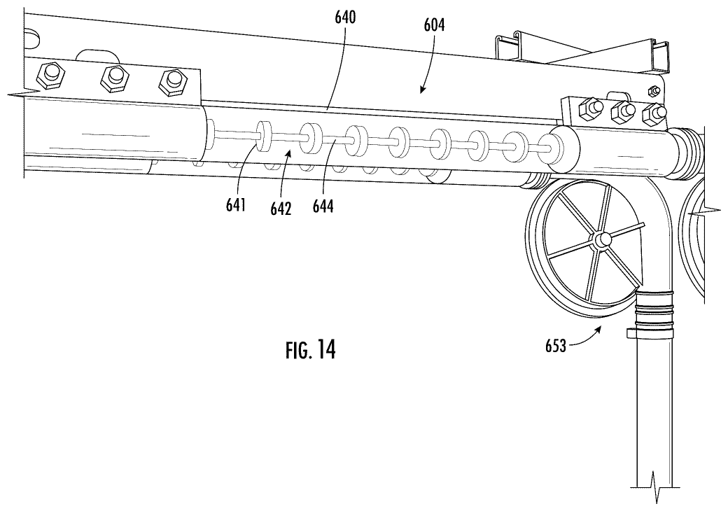

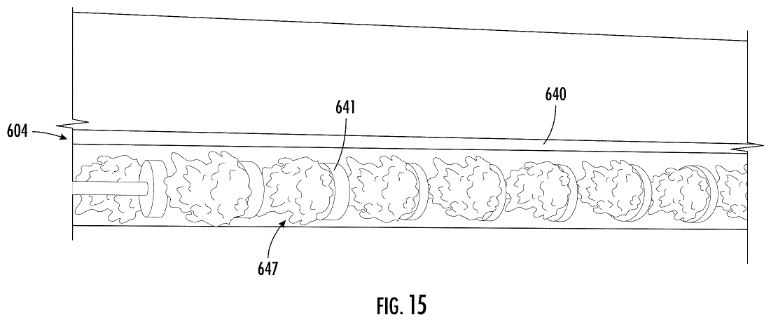

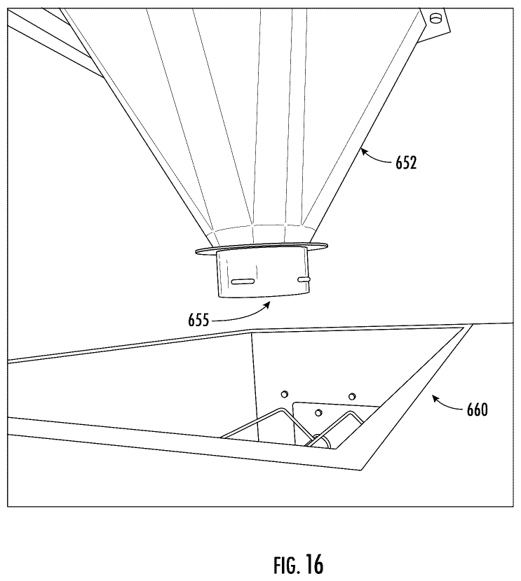

Dispersal system 606 generally comprises an upper funnel-shaped vessel 652 that collects the nanoparticles from conveyer 604, a feed bin 660 and one or more lower funnel-shaped vessels 670. As shown in FIGS. 8 and 16, upper funnel-shaped vessel 652 has an upper opening 650 coupled to the opening in tube 640 of elevator 604 and a lower opening 655 coupled to feed bin 660. The lower opening 655 has a substantially smaller cross-sectional area than the upper opening 653 such that the nanoparticles are “funneled” downwards to control the flow rate of the nanoparticles through the system. Similar to collection vessel 620, vessel 652 may also include one or more vibration elements that pulse the nanoparticles and inhibit them from forming into clumps. These vibration elements may, for example, be located on the outer walls of vessel 652. Alternatively, the vibration elements may be positioned within vessel 652 to facilitate the conveyance of the nanoparticles through vessel 652.

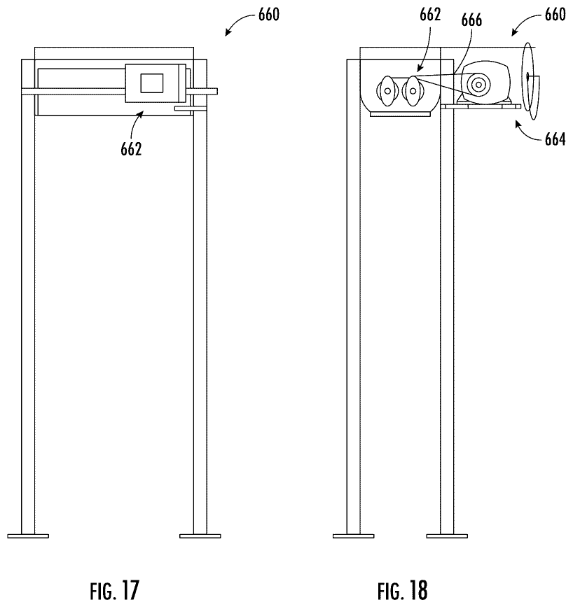

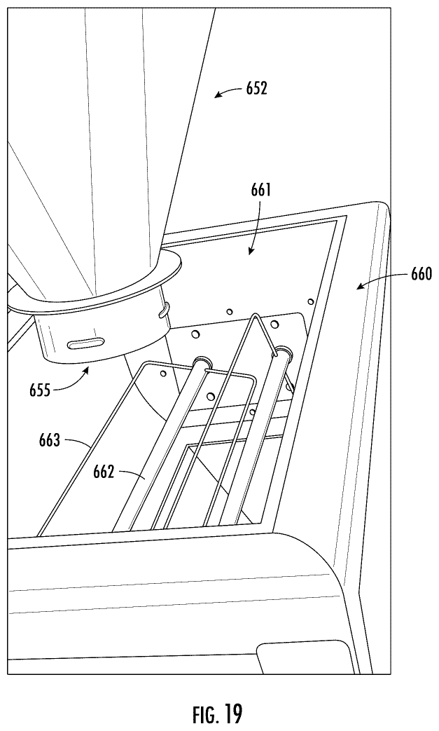

Referring now to FIG. 19, feed bin 660 comprises a first opening 661 for receiving the nanoparticles from vessel 652 and a second opening (not shown) for conveying the nanoparticles to lower vessel 670. Feed bin 660 further includes one or more mechanisms within the interior of feed bin 660 to convey the nanoparticles therethrough. As shown in FIGS. 18 and 19, feed bin 660 preferably includes one or more rotating cylinders 662 extending through the interior of feed bin 660. One or more rods 663 are coupled to cylinders 662 and configured to rotate therewith to sweep the nanoparticles downward through feed bin.

Referring now to FIGS. 8 and 20, feed bin further includes an auger 664 that functions to move the nanoparticles in a generally horizontal direction through feed bin 660 to lower vessel 670. In a preferred embodiment, auger 664 includes a plurality of curved blades 665 that function to receive clusters of nanoparticles that have fallen vertically into feed bin 660 and to redirect these nanoparticles in a horizontal direction through feed bin 660. Curve blades 665 also function to control the volumetric flow rate of the nanoparticles through the feed bin 660 and into the filter manufacturing system. Auger 664 may be driven by any suitable motor 666, such as any of those described above.

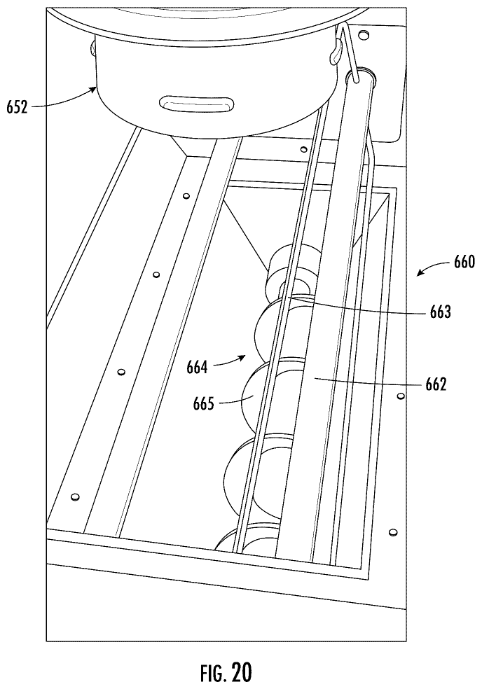

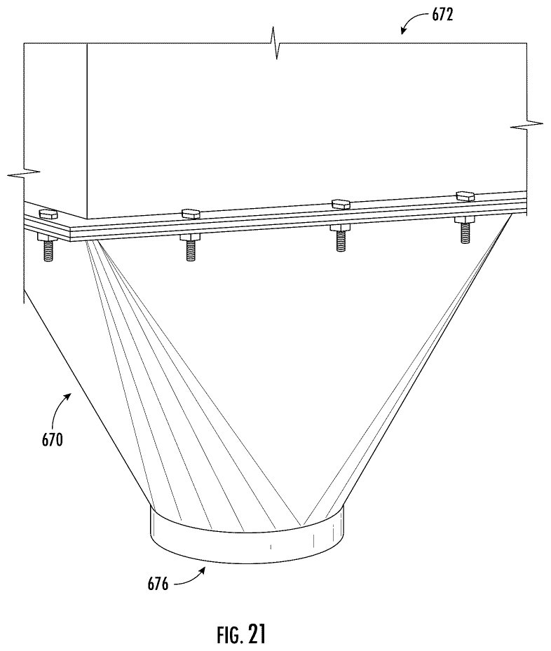

Referring now to FIGS. 8 and 21, lower vessel 670 has an upper opening 672 coupled to an opening in feed bin 660 and a lower opening 676 coupled to the fiber manufacturing system described above. Lower vessel 670 preferably has a substantially funnel shape such that the lower opening has a smaller cross-sectional area than the upper opening to control the flow rate of nanoparticles passing therethrough. Similar to collection vessel 620, lower vessel 670 may include one or more vibration elements that pulse the nanoparticles and inhibit them from forming into clumps. These vibration elements may, for example, be located within the internal walls of vessel 670. Alternatively, the vibration elements may be positioned to facilitate the conveyance of the nanoparticles through vessel 670.

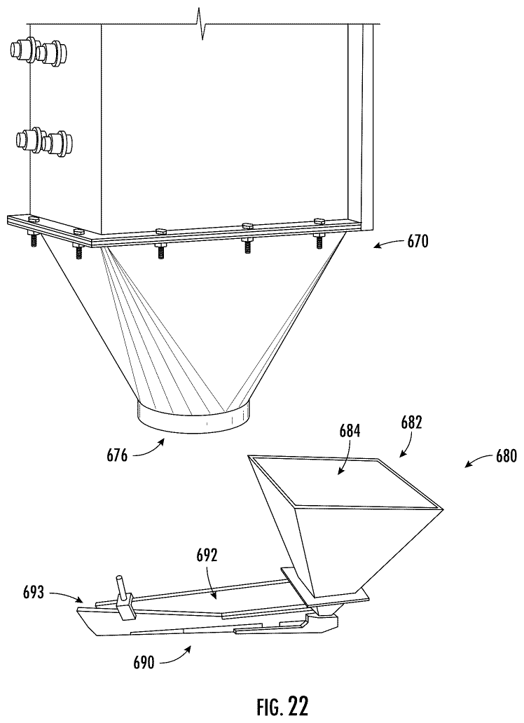

Referring now to FIG. 22, feed system 600 may further include a fine-tuned flow control device 680 that receives nanoparticles from vessel 670 and provides a final control of the volumetric flow rate of the nanoparticles into the filter manufacturing apparatus. Flow control device 680 includes a funnel-shaped vessel 682 with an opening 684 for receiving the nanoparticles from vessel 670 and a lower opening (not shown) coupled to a feeder tray 690. Feeder tray 690 includes a feed channel 692 that tapers towards an opening 693. Opening 693 may be coupled to any suitable filter media manufacturing apparatus, such as any of those discussed above, or others that may be contemplated by those of skill in the art.

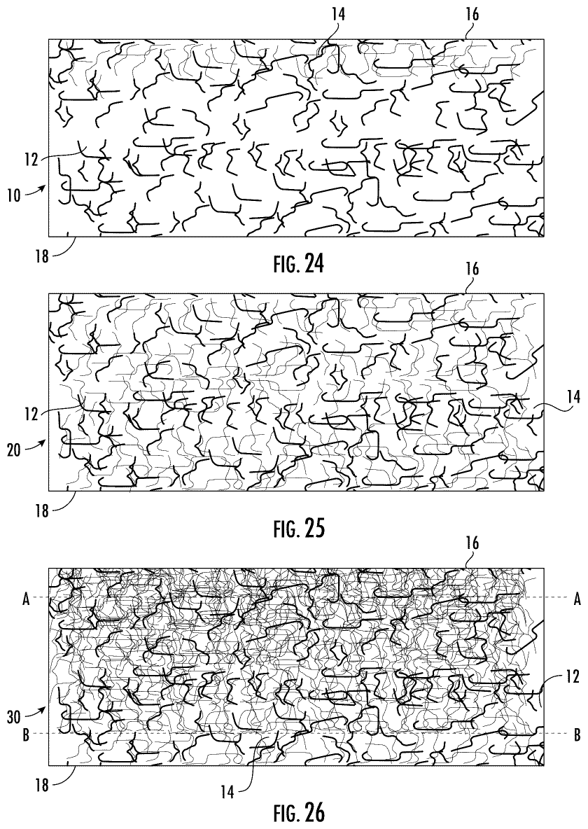

Referring now to FIGS. 24-30, representative filter medias that may be manufactured by any of the above systems will now be described. FIG. 24 illustrates a representative filter media or substrate 10 that includes a plurality of fibers 12 and nanoparticles 14 that have manufactured by the systems and methods described above. Substrate 10 has a first surface 16 and a second surface 18 opposing the first surface 16 and defined a width or thickness between first and second surfaces 16, 18. The nanoparticles 14 have been deposited into the substrate through first surface 16. As shown, nanoparticles 14 penetrate through first surface 16 into the “depth” of the substrate 10 between the first and second surfaces 16, 18. In some embodiments, the nanoparticles 14 penetrate from the first surface at least 25% of the width or thickness between the first and second surfaces 16, 18, or more preferably at least about 50% of the thickness. In other embodiments, the nanoparticles 14 penetrate substantially throughout the substrate 10 from first surface 16 to second surface 18.

The nanoparticles 14 preferably comprise individual nanoparticles that have been broken up, separated and isolated from each other prior to dispersion into substrate 10, as discussed above. As such, the nanoparticles 14 are not present in the fibrous product in a layer, and do not have significant clumping or bundles of nanoparticles. This provides a greater dispersion of nanoparticles throughout the substrate, which in some applications, such as gas or air filters, provides a more efficient filtering capacity for filtering out contaminants. In addition, this provides a filter media with a greater area density of nanoparticles in grams per square meter (gsm) within the material or “add-on amount”. The term “add-on amount” is used herein to mean the area density (gsm) of a material, fiber or particle in a thin layer, sheet or film of material.

In certain embodiments, the nanoparticles may comprise an add-on amount of about 0.1 grams/m² to about 20 grams/m², preferably at least about 2.0 grams/m². The specific add-on amount or area density may depend on the application. For example, Applicant has found that a higher area density or add-on amount will increase the efficiency of the filter media in filtering out contaminants. Thus, the specific add-on amount of nanoparticles may depend on the desired efficiency of a filter media.

FIG. 25 illustrates a filter media or substrate 20 that includes a plurality of fibers 12 and nanoparticles 24 that have manufactured by the systems and methods described above. As shown, nanoparticles 14 penetrate throughout the entire width of substrate 20 from first surface 16 to second surface 18. In certain embodiments, the nanoparticles 14 are substantially dispersed throughout the fibers 12 of substrate, as shown in FIG. 25. In certain embodiments, the density of nanoparticles located at first surface 16 differs by less than 50% of the density of nanoparticles dispersed within the central portion of substrate 20 between surfaces 16, 18. In some embodiments, this difference is less than 25%, preferably less than 10%. In certain embodiments, the amount or number of individual nanoparticles dispersed within the central portion of substrate 20 is at least about 50% of the amount of individual nanoparticles dispersed at or near first surface 16, preferably at least about 75% and more preferably at least about 90%.

In other embodiments, nanoparticles 14 are disposed in a density gradient from first surface 16 to second surface 18. For example, FIG. 26 illustrates a substrate 30 wherein the nanoparticles 14 form a density gradient with a higher density of nanoparticles 14 disposed near first surface 16 than second surface 18. In certain embodiments, the density of nanoparticles located at first surface 16 differs by greater than about 75% of the density of nanoparticles dispersed at second surface 18. In some embodiments, this difference is greater than 50%. In some embodiments, the difference is greater than 25%. In certain embodiments, the amount or number of individual nanoparticles dispersed at or near second surface 18 is less than about 50% of the amount of individual nanoparticles dispersed at or near first surface 16, preferably less than about 25% and more preferably less than about 10%.

The density gradient shown in FIG. 25 may be substantially linear from first surface 16 to second surface 18. Alternatively, the density of the nanoparticles 14 may reduce from first surface 16 to second surface 18 in a series of discrete steps, or the gradient may be random (i.e., a generally reduction in density that is not linear or stepped).

In other embodiments, the nanoparticles may be added into the substrate from both the first and second surfaces 16, 18. In these embodiments, the area density or “add-on amount” at first and second surfaces 16, 18 may be substantially equal to each other, or they may be different depending on the application. In these embodiments, the area density or “add-on amount” that is present in the middle of the substrate is lower than at surfaces 16, 18. For example, the area density in the middle of the substrate may be about 75% of the area density at surfaces 16, 18, or it may be about 50%, 40% or 25%.

The distribution of nanoparticles across the thickness of the filter media can be measured, for example, using imaging techniques. A magnified view of the fibrous product, using an electron microscope or other techniques, taken at a horizontal section of the product at the middle of the thickness of the product can be compared to an image taken at the upper or lower surface of the product, or all three images can be compared, to determine the extent to which the amount of nanoparticles deposited varies. Computerized image analysis processing can be employed. For example, in FIG. 25, a section can be taken at line A-A and a section can be taken at B-B. A top view image of each section can be taken through electron microscope, scanning electron microscopy, and other microscopes. A top view image of the section taken at section A-A, for example, can be compared to a top view image taken at section B-B. The number of microfibers, the number of nanoparticles, or both, in samples of the same two-dimensional size can be assessed and compared. In addition, imaging techniques can be used on three dimensional samples. These techniques can be used to assess the orientation of fibers and other characteristics. These techniques can be used to determine that nanoparticles have been deposited into the depth of the substrate, have been deposited substantially across a significant portion of the substrate, substantially across the entire depth, or across some portion of the depth of the substrate.

The contemplated fibers of the substrate can be manufactured by any method, including, without limitation, the thermally bonded, cellulose wet laid, glass wet laid, synthetic wet laid, composite wet laid, needle punch, meltblown, air laid, spinneret, gel spinning, melt spinning, wet spinning, dry spinning, islands-in-a sea staple or spunbond, segmented pie staple or spunbond, and others. Such methods are described in U.S. Pat. Nos. 4,406,950, 6,338,814, 6,616,435, 6,861,142, 7,252,493, 7,300,272, 7,309,430, 7,422,071, 7,431,869, 7,504,348, 7,774,077 9,522,357, 9,993,761 and US Patent Publication No. 2009/266,759, the completed disclosures of which are hereby incorporated herein by reference for all purposes.

The fibers contemplated may have many shapes in cross-section, including without limitation, circular, kidney bean, dog bone, trilobal, barbell, bowtie, star, Y-shaped and others. These shapes and/or other conventional shapes may be used with the embodiments to obtain the desired performance characteristics. The fibers in the substrate stay connected to each other through thermal bonds, chemical bonds, by being entangled with one another, through the use of binding agents, such as adhesives, or the like.

The fibers may be artificial or natural fibers. Suitable materials for the fibers include, but are not limited to, metallic fibers, carbon fibers, polypropylene (PP), polyesters (PET), PEN polyester, PCT polyester, polybutylene (PBT), ethylene polyester (PET), polylactic acid (PLA), polyamide (PA),co-polyamides, polyethylene, high density polyethylene (HDPE), low density polyethylene (LDPE), cross-linked polyethylene, polycarbonates, polyacrylates, polyacrylonitriles, polyfumaronitrile, polystyrenes, styrene maleic anhydride, polymethylpentene, cyclo-olefinic copolymer or fluorinated polymers, polytetrafluorocthylene, perfluorinated ethylene and hexfluoropropylene or a copolymer with PVDF like P(VDF-TrFE) or terpolymers like P(VDF-TrFE-CFE), propylene, polyimides, polyether ketones, cellulose ester, nylon and polyamides, polymethacrylic, poly(methyl methacrylate), polyoxymethylene, polysulfonates, acrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymer, phenolic, polyurethane, cellulose, styrene or any combination thereof. Other conventional fiber materials are contemplated.

The fibers may include fibers of different sizes, with the fibers generally having diameters ranging from about 1 to about 1000 microns with lengths ranging from about one half to three inches. The fibers may be configured as a gradient density media in which the pore size decreases from the upper surface of the filter (upstream) to the lower surface (downstream) to increase capture efficiency and dust holding capacity. This configuration also allows for the dispersion of different amounts of nanoparticles to the filter media at different depths. For example, the upstream side of the filter media may have the largest fiber size to allow for more void space and a greater density of nanoparticles, while the downstream side of the filter media has fibers with smaller sizes to provide a lower density of nanoparticles. Alternatively, this structure may be reversed to provide a greater density of nanoparticles in the downstream portion of the filter media.

The fibers in the media may stay connected to other fibers by being thermally bonded, chemically bonded or entangled with one another. Bicomponent fibers may be used, particularly with mechanical filtration, and these are formed by extruding two polymers from the same spinneret with both polymers contained within the same filament. Suitable materials for bicomponent fibers include, but are not limited to, polypropylene (PP)/polyethylene (PE), polyethylene terephthalate (PET)/polypropylene (PP) and the like.

In some embodiments, the substrate may comprise a “high loft” filter media comprising spunbond or air through bonded carded fibers. As used here in the term “high loft” means that the volume of void space is greater than volume of the total solid. In air through bonded carded nonwoven fibers, the loftiness of a substrate can be controlled by various means known to those of skill in the art. For example, loftiness can be increased by applying less compression force onto the media during bonding. In another example, a high loft nonwoven material can be manufactured with fibers having larger thicknesses, such as thicknesses greater than 3 denier, e.g., 5 denier or greater, 6 denier or greater (discussed in more detail below). In other embodiments, the loftiness may be increased by using eccentric biocomponent fibers, as shown in FIG. 5C and discussed in more detail below.

In certain embodiments, the fibers may include a silicone-based coating to improve the efficiency of the filter media at capturing contaminants, particularly contaminants in the E2 and E3 particle group range. The silicone-based coating may comprise a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. Suitable silicone coatings are described in commonly assigned U.S. Provisional Patent Application Ser. No. 63/406,686, filed Sep. 14, 2022, the complete disclosure of which is incorporated herein by reference.

The filtration media may comprise a charge additive to modify the triboelectric charge of the fibers and increase the stability and/or duration of the triboelectric charge in the filter. This increases the overall filtration efficiency of the filter without compromising other important characteristics of the filters, such as longevity, dust holding capacity, and the pressure drop or air flow through the filter. Suitable charge additives for triboelectric charging are described in commonly assigned Provisional Patent Application Ser. No. 63/410,731, filed Sep. 28, 2022, the entire disclosures of which are hereby incorporated by reference herein for all purposes.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in linear mass density of fibers. In some embodiments, the fibers may have a linear density of about 1 denier to about 10 denier. The nanoparticles are fibers having at least one dimension in the range of about 1 to about 1,000 nanometers or about 1 to about 100 nanometers. The dimensions described above fibers and nanoparticles may be a diameter or a width, depending on the shape of the fiber or nanoparticle.

For gas filters, such as pleated or unpleated air filters, the fibers may have a linear density in the range of about 1 denier to about 10 denier. The filter media may comprise fibers with the same or different linear densities.

Fibers in air filters typically have a linear density of about 3 denier or less to ensure that the fibers are small enough to capture contaminants passing through the filter. Applicant has surprisingly found that with the use of nanoparticles dispersed through the filter media, the fibers may have larger linear densities, e.g., greater than 3 denier. This is because the nanoparticles provide a significant filtering capability. In some cases, the fibers may have linear densities of greater than 3 denier, 5 denier or greater, 6 denier or greater or as large as 7-10 denier.

Applicant has also found that, in some applications, fibers with larger linear densities than used in conventional filters (e.g., greater than about 3 denier) provide more open space or pores within the filter media, which allows for a greater density of nanoparticles to be dispersed therein. While this may be counterintuitive to those of skill in the art, Applicant has discovered that fibers with larger linear densities that incorporate nanoparticles actually improves the overall efficiency of the filter.

In certain embodiments, a filter media may include at least two different fiber thicknesses or linear densities to provide at least two different layers of filter within the same filter media. For example, in some cases, one portion of the filter media will include fibers with linear densities greater than 3 denier, for example, 5 denier or greater or 6 denier or greater. The other portion of the filter media will comprise fibers with more standard linear densities of 3 denier or less. This dual-layer filter media creates a first filter portion that filters contaminants primarily with nanoparticles that have a high density within the larger thickness fibers and a second filter portion that filters contaminants primarily with the fibers having lower linear densities, although both portions may include nanoparticles dispersed throughout the fibers. In certain embodiments, the filter media may include three or more separate portions or layers with different denier fiber ranges within each portion.

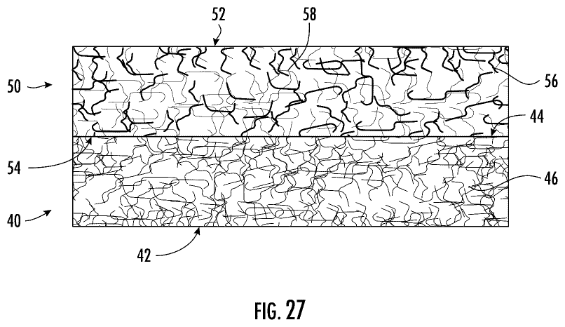

FIG. 27 illustrates a dual layer filter media that includes a first substrate 40 having a first surface 42 and a second surface 44 opposing the first surface; and a second substrate 50 having a first surface 52 and a second surface 54 opposing the first surface. Second surface 44 of substrate 40 is bonded to second surface 54 of first substrate in any manner known to those skilled in the art. First substrate 40 contains fibers 46 of relatively smaller linear density, e.g., on the order of 3 denier or less. Second substrate 50 contains fibers 56 of relatively larger linear densities, e.g., on the order of 3 denier or greater, such as 5 denier, 6 denier or larger. Second substrate 50 also includes individual nanoparticles 58 dispersed throughout and bonded to fibers 56 and/or retained by second substrate 50. First substrate 40 may, or may not, also include nanoparticles.

First substrate 40 is configured to filter contaminants primarily with fibers 46, although as mentioned previously, first substrate 40 may also include nanoparticles. Second substrate 50 is configured to filter contaminants with both fibers 56 and nanoparticles 58.

In some embodiments, the substrate may compromise additives, such as antibacterial and/or antiviral compositions such as silver, zinc, copper, organosilicone, tributyl tin, organic compounds that contain chlorine, bromine, or fluorine compounds.

The fibers may include biocomponent fibers that include two or more different fibers bonded to each other. The fibers may comprise the same material, or different materials.

In certain embodiments, the filter media (i.e., the fibers and/or the nanoparticles) may be electrostatically charged such that, for example, contaminants are captured both with mechanical and electrostatic filtration. The bond between the fibers and the nanoparticles may also be enhanced by electrostatically charging the nanoparticles, the fibers or both. For example, in certain embodiments, the fibers are electrostatically charged such that mechanical filtration can be achieved by nanoparticles while electrostatic filtration can be achieved through electret substrate. The electrostatic or electret substrate could be high loft triboelectric filter media made by carding and needling. In one of the embodiments, the nanoparticles are preferably deposited into the substrate before needling and then both electrostatic fibers and nanoparticles are needled together.

The substrate, the nanoparticles, or both can be electrostatically charged using triboelectric methods, corona discharge, electrostatic fiber spinning, hydro charging, charging bars or other known methods. Corona charging is suitable for charging monopolymer fiber or fiber blend, or fabrics. Tribocharging may be suitable for charging fibers with dissimilar electronegativity. Electrostatic fiber spinning combines the charging of the polymer and the spinning of the fibers as a one-step process. Suitable charge additives for triboelectric charging are described in commonly assigned Provisional Patent Application Ser. No. 63/410,731, filed Sep. 28, 2022, the entire disclosures of which are hereby incorporated by reference herein for all purposes.

The nanoparticles can be chosen with different triboelectric properties relative to the fibers in order to use a triboelectric effect to enhance particle removal. With this method, the generated nanoparticles are formed in an electrical field and are less subject to contamination by chemicals that may moderate the triboelectric effect. Nanoparticles with different adsorption properties or surface charge characteristics than the coarse fibers can also be used, e.g. in oil or water filtration. This difference can be used to enhance or create localized electrical field gradients within the filter media to enhance particle removal. The nanoparticles and coarse fibers may have different wetting characteristics.

In certain embodiments, the filter medias discussed herein may be included as part of a filter device that traps or absorbs contaminants, such as a liquid filter, a gas filter for home and commercial air filtration, a surgical mask or other face covering or the like. The filter device may be a mechanical filter, absorption filter, sequestration filter, ion exchange filter, reverse osmosis filter, surface filter, depth filter or the like, and may be designed to remove many different types of contaminants from air, water, or others.

In one such embodiment, the filter medias are incorporated into an air filter that removes particles and contaminants from the air, such as a HEPA filter (i.e., pleated mechanical air filter), an HVAC filter, a UV light filter, an electrostatic filter, a washable filter, a media filter, a spun glass filter, pleated or unpleated air filters, active carbon filters, pocket filters, V-bank compact filters, filter sheets, flat cell filters, filter cartridges and the like. The filter medias may comprise a filter media for the air filter and may be supported by a support layer, a scrim layer, or may be included in other layers or materials. Applicant has discovered that incorporating nanoparticles in depth into filter medias as discussed herein substantially increases the efficiency of the air filter without compromising other factors, such as pressure drop (i.e., air flow) through the filter. In addition, these materials increase the overall dust holding capacity and thus the life of the filter, particularly compared to filters that rely solely or primarily on electrostatic effects to increase efficiency.

Conventional home and commercial air filters, such as HEPA and HVAC filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. Conventional mechanical air filters typically report MERV ratings for fibrous filtration materials of about 8.

Air filters are typically rated based on their initial efficiency (i.e., the efficiency of the air filter prior to use) and their efficiency over time and use. This latter efficiency is typically tested through a conditioning step, referred to as ASHRAE Standard 52.2 Appendix J.

The air filters provided herein have an initial MERV rating greater than about 10 and a pressure drop less than about 0.5 inches of water. In some cases, the initial MERV rating is about 11 and the pressure drop is equal to or less than about 0.17 inches of water, or about 13 and the pressure drop is equal to or less than about 0.36 inches of water, or about 14 and the pressure drop is equal to or less than about 0.5 inches of water.

The gas filters provided herein have a MERV rating of 10 or greater after the gas filter has been conditioned with ASHRAE Standard 52.2 Appendix J. In some embodiments, the MERV rating is 13 or greater after the gas filter has been conditioned with ASHRAE Standard 52.2, ISO Standard 16890 or any other acceptable standard in the industry.

The MERV rating of the fibrous filter media discussed herein will vary based on many factors, including the types and sizes of fibers used in the filter media, the density of individual nanoparticles within the filter media, the width of the filter media, the number and size of pleats (if any) and the like. The MERV rating can be measured for a sheet of the fibrous product, as well as the fibrous product formed as a pleated filter media, and the pressure drop for each can vary. Likewise, the pressure drop across the filter media will also depend on many factors, including those mentioned above.

One factor that impacts both MERV rating and pressure drop is the density or add-on amount of the nanoparticles within the substrate relative to the density of the fibers within the substrate. Applicant has discovered that the lower the ratio between substrate density and nanoparticle density, the higher the MERV rating of the filter and the higher the pressure drop. In certain embodiments, the filter media described herein have a nanoparticle area density of about 0.1 grams/m² to about 20 grams/m², preferably at least about 2 grams/m².

In some situations, the density of the nanoparticles will also depend on the density of the actual filter media (i.e. the density of the coarse fibers). As discussed in more detail below in reference to Table 2 below, a density ratio of about 67 (substrate gsm divided by add-on nanoparticles gsm) resulted in a pressure drop of about 0.14 inches of water and an initial MERV rating of 10. A density ratio of about 33.4 increased the MERV rating to 10 while only resulting in an increase in pressure drop to about 0.17. A density ratio of about 22.3 increased the initial MERV rating to about 12 with a pressure drop of about 0.24 inches of water.

Thus, the efficiency or MERV rating of the filter may increase with higher add-on amounts of nanoparticles. In particular, Applicant has discovered that, for example, with add-on amounts of at least 2 g/m², a filter having a MERV rating of about 10 may be achieved. Add-on amounts of 4 or 6 g/m² provide a filter with a MERV rating of about 12 and 13, respectively. Add-on amounts of 10 g/m² or higher result in a filter with a MERV rating of 15 or higher.

Applicant has also discovered that including fibers with greater thicknesses or linear densities result in larger pore size and thus more pore volume, thereby allowing for a higher density of nanoparticles within the substrate. This results in a higher MERV rating and pressure drop (as discussed below in reference to Table 2). For example, Applicant has been able to produce an air filter with a MERV rating of 14 and a pressure drop of 0.5 inches of water with 5 denier biocomponent fibers. Similarly, Applicant was able to produce a filter with a MERV rating of 13 and a pressure drop of only about 0.29 inches of water with 5 denier biocomponent fibers.

The fibrous products disclosed herein may be used in medical masks or other medical applications, such as cartridges in respirators. Medical masks are designed to protect healthcare personnel and/or patients from microbials and other materials. For example, medical masks can block bacteria, which can have a dimension of about 3 microns, for example, as well as viruses, which can have a dimension of about 0.1 microns, for example. The masks are made using filter medias in multiple layers, and have car loops, ties, or other structures for attaching the mask to a person's face. A wire may be incorporated into at least an upper portion of the mask so that at least that portion conforms to the person's face. The mask can include rigid polymeric structures designed to hold the multilayer filter medias in front of a person's face. In one example, the mask has three layers. The outer layer and inner layer comprise a filter media such as spunbond polypropylene that provides breathability, although any of the materials mentioned herein can be used. The middle layer is disposed between the inner layer and outer layer and comprises a microfiber substrate having nanoparticles deposited into the depth of the substrate to provide an initial MERV of greater than 8, preferably a MERV greater than 10, and more preferably a MERV of 13 or more. The pressure drop through the mask is 3 to 6 mm of water, more preferably 4 mm of water for breathability. It is desirable for the mask to have an efficiency of about 95%. Other examples of masks have four or more layers. Multiple layers of the fibrous products can be combined in a single mask.

In certain embodiments, the filter media may be included in a thin film or layer that includes apertures, pores or perforations. The apertures may be embossed in a pattern (such as circular, diamond shaped, hexagonal, oblong, triangular, rectangular, etc.) and then stretched until apertures form in the thinned out areas created by the embossing. Such an apertured substrate can be formed from many polymers, such as polypropylene, polyethylene, high density polyethylene (“HDPE”) and the like. The polymer layer may, for example, comprise an extruded film. An apertured film is available commercially and is marketed under the trademark Delnet®. The substrate is provided in a roll and nanoparticles are deposited into the substrate in a roll to roll process.

In other embodiments, a gas filter comprises a filter media and a substantially rigid support layer bonded to the filter media. The support layer includes fibers and individual nanoparticles dispersed in depth within the layer. The nanoparticles are configured to filter contaminants passing through the support layer.

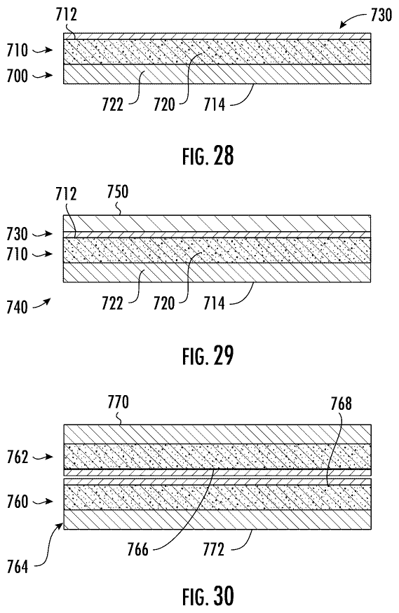

FIG. 28 illustrates a filter product 700 including a filter media 710 of filter media including fibers 722 and nanoparticles 720 dispersed through at least a portion of filter media 710. As shown, filter media 710 has a first upper surface 712 and a second lower surface 714. The nanoparticles have been dispersed through upper surface 712 such that they extend beyond upper surface 712 and into the depth of filter media 710, as discussed above. Filter product 700 further includes a support layer 730, which may be any suitable support layer known in the art, such as a substantially rigid polymer that provides support for filter media 710, or an apertured film having a plurality of apertures for passage of gas or fluid therethrough (discussed above).

FIG. 29 illustrates another filter product 740 that includes a filter media 710 of filter media including fibers 722 and nanoparticles 720 dispersed through a portion of filter media 710. In this embodiment, product 740 includes a scrim layer 750 bonded to a support layer 730.

FIG. 30 illustrates a dual-layer filter product 760 that includes first and second filter medias 762, 764 bonded to each other. As shown, nanoparticles 720 have been dispersed throughout a depth of each filter media 762, 764. In this embodiment, nanoparticles 720 have been dispersed through inner surfaces 766, 768 of filter media 762, 764. In another embodiment (not shown), the nanoparticles are dispersed through outer surfaces 770, 772 of filter media 762, 764. In yet another embodiment, nanoparticles 720 may be deposited on inner surface 766 of media 762 and outer surface 772 of media 764.

### Example 1

A microfiber substrate of bicomponent fibers having an inner circular section of polyester, and an outer concentric section of HDPE was provided in a roll. In a roll to roll process, the substrate was sprayed with adhesive, and nanoparticles of biosoluble glass fiber or nanoparticles were deposited. The nonwoven product was then heated in an oven, and the cooled nonwoven product was gathered onto another roll.

Nanoparticles are deposited according to processes described in FIGS. 12-16 below. In experiments, bio soluble glass nanoparticles are used. Nanofiber diameter is about 700 nm while the length is about 500 microns. Carded air through bonded nonwovens made of bicomponent fibers are used as substrate in the following examples:

Flat sheet filter media samples tested at 110 fpm filtration velocity. Sample size was 12″×12″. NaCl salt particles in the range of 0.3 to 10 micron were used as contaminants.

### Example 2

A carded nonwoven made of 3 denier PET/PE bicomponent fiber is used as substrate. A composition compromising water, 2-hexoxyethanol, isopropanolamine, sodium dodecylbenzene sulfonate, lauramine oxide, ammonium hydroxide is used as binder. Different nanofiber add-on amounts are controlled via adjusting line speed.

TABLE 1

| | | Nanoparticle | Pressure | Particle Groups | | | MERV |
|---|---|---|---|---|---|---|---|
| Sample | gsm | add-on gsm | drop ″H20 | E1 | E2 | E3 | Rating |
| Substrate | 54.9 | | 0.07 | 0 | 17 | 58 | 7 |
| A1 | 55.7 | 0.82 | 0.14 | 23 | 62 | 94 | 10 |
| A2 | 56.5 | 1.64 | 0.17 | 32 | 73 | 97 | 11 |
| A3 | 57.4 | 2.46 | 0.24 | 47 | 86 | 98 | 12 |

This example illustrates that by controlling the add-on amount of nanoparticles, MERV ratings are increasing from MERV 7 to up to MERV13.

### Example 3

A high loft air through carded nonwoven with 5 denier bicomponent fiber is used as a substrate. A typical starch binder is diluted and sprayed before nanofiber deposition. Starch bonded nanoparticles adequately as solvent evaporates and drying occurs under IR heater.

TABLE 2

| | Pressure | Particle Groups | | | MERV |
|---|---|---|---|---|---|
| Sample | drop ″H20 | E1 | E2 | E3 | Rating |
| B1 | 0.1 | 24% | 58% | 88% | 10 |
| B2 | 0.17 | 34% | 71% | 90% | 11 |
| B3 | 0.26 | 47% | 85% | 98% | 12 |
| B4 | 0.29 | 59% | 91% | 99% | 13 |
| B5 | 0.5 | 76% | 97% | 100% | 14 |

### Example 4

Spunbond or meltblown media were used as a substate with the nanoparticles being incorporated into the substrate as described herein after IPA discharge. The spunbond fibers were made from a melted polymer that was spun and drawn to produce filaments. The average basis weight of the substrates was about 90 gsm and the average thickness was about 0.57 mm. A base sample was used that did not incorporate any nanoparticles. 4 separate samples were prepared that included nanoparticles incorporated into the substrate as described herein. In sample 2, the nanoparticles were incorporated into meltblown fibers after IPA discharge. In samples 1, 3 and 4 the nanoparticles were incorporated into spunbond fibers after IPA discharge. The results of this testing are shown in Table 3 below.

TABLE 3

| Sample # | Substrate | PD | E1 | E2 | E3 | MERV |
|---|---|---|---|---|---|---|
| 1 | CAB81 | 0.41 | 96% | 100% | 100% | 16 |
| | (spunbond) | | | | | |
| 2 | CAB81 | 0.24 | 75% | 98% | 100% | 14 |
| | (meltblown) | | | | | |
| 3 | CAB81 | 0.40 | 92% | 100% | 100% | 15 |
| | (spunbond) | | | | | |
| 4 | CAB81 | 0.17 | 48% | 87% | 99% | 12 |
| | (spunbond) | | | | | |
| Base | CAB81 | 0.07 | 9% | 46% | 90% | 9 |
| | (spunbond) | | | | | |

As shown, the efficiency of the filter media samples incorporating nanoparticles increased over the base sample in all three particle groups with significant increases in the E2 and E3 particles groups. The overall MERV ratings of the samples increased from MERV 7 (base sample) to MERV 12 to MERV 16 with nanoparticles. The base sample without nanoparticles had a pressure drop of 0.07 inches of water. Samples 1-4 had a slightly increased pressure drop ranging from 0.17 to 0.41 inches of water. In Sample 2, wherein the nanoparticles were incorporated into meltblown fibers, the MERV rating was 14 and the pressure drop was 0.24 inches of water.

### Example 5

5 Denier air through carded fibers were used as a substate. A base sample was used that did not incorporate nanoparticles. 2 separate samples were prepared that included nanoparticles incorporated into the substrate as described herein. The results of this testing are shown in Table 4 below.

TABLE 4

| Sample # | Substrate | PD | E1 | E2 | E3 | MERV |
|---|---|---|---|---|---|---|
| Base | 5D Fiber | 0.03 | −1% | 2% | 38% | 6 |
| | Carded | | | | | |
| 1 | 5D Fiber | 0.31 | 57% | 90% | 98% | 13 |
| | Carded | | | | | |
| 2 | 5D Fiber | 0.33 | 61% | 92% | 98% | 13 |
| | Carded | | | | | |

As shown, the efficiency of the filter media samples incorporating nanoparticles increased substantially over the base sample in all three particle groups. The overall MERV ratings of the samples increased from MERV 6 (base sample) to MERV 13 with nanoparticles. The base sample without nanoparticles had a pressure drop of 0.03 inches of water. Samples 1 and had a slightly increased pressure drop ranging from 0.31 to 0.33 inches of water.

### Example 6

Meltblown fibers were used as a substate. The substrates had an average basis weight of about 24 gsm and an average thickness of about 0.4 mm. A base sample was used that did not incorporate nanoparticles or an adhesive such as PVOH. Sample 1 included meltblown fibers with the belt up. PVOH was sprayed onto the fibers, but nanoparticles were not incorporated therein. sample 2 included meltblown fibers fuzzy side up. PVOH was sprayed onto the fibers, but nanoparticles were not incorporated therein. Sample 3 included meltblown fibers with PVOH sprayed thereon and nanoparticles incorporated into the fibers as described herein. The results of this testing are shown in Table 5 below.

TABLE 5

| Sample # | Substrate | PD | E1 | E2 | E3 | MERV |
|---|---|---|---|---|---|---|
| Base | Meltblown | 0.35 | 82% | 96% | 99% | 14 |
| 1 | Meltblown | 0.38 | 68% | 88% | 93% | 13 |
| 2 | Meltblown | 0.41 | 78% | 95% | 97% | 14 |
| 3 | Meltblown | 1.02 | 92% | 99% | 99% | 15 |

As shown, the efficiency of the sample 3 that incorporated nanoparticles increased over the other three base samples in all three particle groups, particularly in the E1 particle group. The overall MERV rating of sample 3 increased from MERV 13 or 14 (base samples) to MERV 15 with nanoparticles. The PVOH added to samples 2 and 3 did not substantially increase the pressure drop (i.e., 0.35 in the base sample and 0.38 and 0.41 in samples 1 and 2. The pressure drop of sample 3 did increase from a about 0.40 inches of water to about 1 inches of water. In Sample 3, wherein the nanoparticles where incorporated into the meltblown fibers, the MERV rating was 15 and the pressure drop was 1.02 inches of water.

### Example 7

5 Denier air through carded fibers were used as a substate. A base sample was used that did not incorporate nanoparticles. Seven additional samples were prepared that included 5 Denier carded fibers with nanoparticles incorporated into the substrate as described herein. The results of this testing are shown in Table 6 below.

TABLE 6

| Sample # | Substrate | PD | E1 | E2 | E3 | MERV |
|---|---|---|---|---|---|---|
| Base | 5D Fiber | 0.03 | −1% | 2% | 38% | 6 |
| | Carded | | | | | |
| 1 | 5D Fiber | 0.07 | 7% | 31% | 69% | 7 |
| | Carded | | | | | |
| 2 | 5D Fiber | 0.09 | 5% | 36% | 69% | 7 |
| | Carded | | | | | |
| 3 | 5D Fiber | 0.15 | 16% | 51% | 77% | 9 |
| | Carded | | | | | |
| 4 | 5D Fiber | 0.16 | 21% | 58% | 81% | 10 |
| | Carded | | | | | |
| 5 | 5D Fiber | 0.17 | 31% | 70% | 90% | 11 |
| | Carded | | | | | |
| 6 | 5D Fiber | 0.28 | 46% | 85% | 96% | 12 |
| | Carded | | | | | |
| 7 | 5D Fiber | 0.32 | 58% | 91% | 97% | 13 |
| | Carded | | | | | |

As shown, the efficiency of the seven samples that incorporated nanoparticles increased over the base sample in all three particle groups, particularly in the E2 and E3 particle groups. The overall MERV ratings were increased from MERV 6 (base sample) to MERV 7 through MERV 13 with nanoparticles. The pressure drop only increased from 0.03 inches of water to a maximum of 0.32 inH20.

### Example 8

High loft spunbond fibers were used as a substate in a continuous fiber line. This trial included two different versions: 205-6 and 205-2 in which the settings were changed on the continuous fiber line to produce two substrates with different weight and thicknesses. A base sample for each version (205-6 and 205-2) was used that did not incorporate nanoparticles. Six additional samples were prepared that included 205-6 and 205-2 fibers with nanoparticles incorporated into the substrate as described herein. The results of this testing are shown in Table 7 below.

TABLE 7

| Sample # | Substrate | PD | E1 | E2 | E3 | MERV |
|---|---|---|---|---|---|---|
| Base | 205-6 | 0.04 | 0% | 9% | 43% | 6 |
| Base | 205-2 | 0.04 | 0% | 8% | 37% | 6 |
| 1 | 205-6 | 0.86 | 88% | 98% | 99% | 15 |
| 2 | 205-2 | 0.48 | 79% | 96% | 99% | 14 |
| 3 | 205-6 | 0.87 | 82% | 97% | 99% | 14 |
| 4 | 205-2 | 0.42 | 61% | 90% | 98% | 13 |
| 5 | 205-6 | 0.78 | 79% | 97% | 99% | 14 |
| 6 | 205-2 | 0.23 | 44% | 79% | 96% | 11 |

As shown, the efficiency of the six samples that incorporated nanoparticles demonstrated substantially increased efficiency over the base sample in all three particle groups. The overall MERV ratings were increased from MERV 6 (base sample) to MERV 11 through MERV 14 with nanoparticles. The pressure drop only increased from 0.04 inches of water to a maximum of 0.87 inches of water. The pressure drops in the 205-2 samples only increased to a maximum of 0.48 in H2O.

### Example 9

Spunbond and meltblown fibers were used as a substate. The average basis weight for the substrates was about 70 gsm for the spunbond fibers and about 24 gsm for the meltblown fibers The average thickness of the substrates was about 0.75 mm. A base sample was used that did not incorporate nanoparticles. Five additional samples were prepared that included spunbond plus meltblown fibers with nanoparticles into the fibers as described herein In samples 1-3, the nanoparticles were sprayed onto the meltblown fibers. In samples 4 and 5, the nanoparticles were sprayed onto the spunbond fibers. Also, in samples 1 and 2, the adhesive PVOH was not sprayed onto the substrate. PVOH was sprayed onto samples 3-5. The results of this testing are shown in Table 8 below.

TABLE 8

| Sample # | Substrate | PD | E1 | E2 | E3 | MERV |
|---|---|---|---|---|---|---|
| Base | Spunbond + MB | 0.07 | 2% | 17% | 29% | 5 |
| 1 | Spunbond + MB | 0.41 | 100% | 100% | 100% | 16 |
| 2 | Spunbond + MB | 0.56 | 100% | 100% | 100% | 16 |
| 3 | Spunbond + MB | 0.26 | 99% | 100% | 100% | 16 |
| 4 | Spunbond + MB | 0.4 | 100% | 100% | 100% | 16 |
| 5 | Spunbond + MB | 0.17 | 97% | 100% | 100% | 16 |

As shown, the efficiency of the five samples that incorporated nanoparticles demonstrated substantially increased efficiency over the base sample in all three particle groups. The overall MERV ratings were increased from MERV 5 (base sample) to MERV 16 with nanoparticles. The pressure drop only increased from 0.07 inches of water to a maximum of 0.56 inches of water. In samples 3-5 (PVOH sprayed onto the substrate), the pressure drop only increased to a maximum of 0.4 inches of water.

### Example 10

5 Denier air through carded glass fibers were used as a substate. A Base sample was used that did not incorporate nanoparticles. Three additional samples were prepared that included 5 Denier carded glass fibers with nanoparticles incorporated therein. The results of this testing are shown in Table 9 below.

TABLE 9

| Sample # | Substrate | PD | E1 | E2 | E3 | MERV |
|---|---|---|---|---|---|---|
| Base | 5D fiber | 0.03 | −1% | 2% | 38% | 6 |
| | carded | | | | | |
| 1 | 5D fiber | 0.27 | 59% | 91% | 99% | 13 |
| | carded | | | | | |
| 2 | 5D fiber | 0.18 | 45% | 83% | 98% | 12 |
| | carded | | | | | |
| 3 | 5D fiber | 0.24 | 54% | 89% | 99% | 13 |
| | carded | | | | | |

As shown, the efficiency of the three samples that incorporated nanoparticles demonstrated substantially increased efficiency over the base sample in all three particle groups. The overall MERV ratings were increased from MERV 6 (base sample) to MERV 12 or MERV 13 with nanoparticles. The pressure drop only increased from 0.03 inches of water to a maximum of 0.27 inches of water.

### Example 11

A fiber blend of 5 Denier and 7 Denier air through carded glass fibers were used as a substate. The media was air through bonded. A Base sample was used that did not incorporate nanoparticles. Nineteen additional samples were prepared that included a fiber blend of 5 Denier and 7 Denier carded glass fibers with nanoparticles incorporated therein. The results of this testing are shown in Table 10 below.

TABLE 10

| Sample # | Substrate | PD | E1 | E2 | E3 | MERV |
|---|---|---|---|---|---|---|
| Base | 5D/7D | 0.03 | −1% | 2% | 38% | 6 |
| | carded | | | | | |
| 1 | 5D/7D | 0.15 | 37% | 64% | 95% | 10 |
| | carded | | | | | |
| 2 | 5D/7D | 0.21 | 33% | 70% | 92% | 11 |
| | carded | | | | | |
| 3 | 5D/7D | 0.17 | 42% | 80% | 98% | 11 |
| | carded | | | | | |
| 4 | 5D/7D | 0.25 | 47% | 82% | 96% | 12 |
| | carded | | | | | |
| 5 | 5D/7D | 0.20 | 48% | 84% | 98% | 12 |
| | carded | | | | | |
| 6 | 5D/7D | 0.22 | 49% | 84% | 98% | 12 |
| | carded | | | | | |
| 7 | 5D/7D | 0.23 | 53% | 85% | 97% | 13 |
| | carded | | | | | |
| 8 | 5D/7D | 0.23 | 53% | 87% | 98% | 13 |
| | carded | | | | | |
| 9 | 5D/7D | 0.23 | 54% | 88% | 98% | 13 |
| | carded | | | | | |
| 10 | 5D/7D | 0.27 | 54% | 88% | 98% | 13 |
| | carded | | | | | |
| 11 | 5D/7D | 0.28 | 54% | 87% | 98% | 13 |
| | carded | | | | | |
| 12 | 5D/7D | 0.24 | 56% | 89% | 98% | 13 |
| | carded | | | | | |
| 13 | 5D/7D | 0.26 | 56% | 88% | 98% | 13 |
| | carded | | | | | |
| 14 | 5D/7D | 0.25 | 57% | 90% | 98% | 13 |
| | carded | | | | | |
| 15 | 5D/7D | 0.27 | 57% | 89% | 98% | 13 |
| | carded | | | | | |
| 16 | 5D/7D | 0.28 | 57% | 89% | 98% | 13 |
| | carded | | | | | |
| 17 | 5D/7D | 0.28 | 58% | 90% | 98% | 13 |
| | carded | | | | | |
| 18 | 5D/7D | 0.30 | 58% | 90% | 98% | 13 |
| | carded | | | | | |
| 19 | 5D/7D | 0.29 | 59% | 89% | 98% | 13 |
| | carded | | | | | |
| 20 | 5D/7D | 0.31 | 65% | 94% | 99% | 13 |
| | carded | | | | | |

As shown, the efficiency of all 19 samples that incorporated nanoparticles demonstrated substantially increased efficiency over the base sample in all three particle groups. The overall MERV ratings were increased from MERV 6 (base sample) to MERV 10 through MERV 13 with nanoparticles (the majority of the samples were rated at MERV 13). The pressure drop only increased from 0.03 inches of water to a maximum of 0.31 inches of water.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment comprises a system for manufacturing a filter media. The system comprises a container for receiving clusters of nanoparticles, one or more vibration elements coupled to the container and configured to pulse the clusters of nanoparticles to convey the clusters of nanoparticles through the container and an apparatus coupled to the container for receiving the nanoparticles, the apparatus comprising one or more components for combining the nanoparticles with fibers to form the filter media.

A second embodiment is the first embodiment, wherein the one or more vibration elements are disposed on the outer walls of the container.

A 3^{rd} embodiment is any combination of the first 2 embodiments, wherein the one or more vibration elements are configured to vibrate the outer walls of the container to separate the nanoparticles from outer walls of the collection vessel.

A 4^{th} embodiment is any combination of the first 3 embodiments, wherein the one or more vibration elements are disposed within the interior of the container.

A 5^{th} embodiment is any combination of the first 4 embodiments, further comprising a power source coupled to the vibration elements.

A 6^{th} embodiment is any combination of the first 5 embodiments, wherein the power source comprises an electric motor.

A 7^{th} embodiment is any combination of the first 6 embodiments, wherein the vibration elements are coupled to a source of compressed air.

An 8^{th} embodiment is any combination of the first 7 embodiments, further comprising a bulk bin for receiving the clusters of nanoparticles and a collection vessel coupled to the bulk bin, wherein the vibration elements are disposed on the collection vessel.

A 9^{th} embodiment is any combination of the first 8 embodiments, wherein the collection vessel has an upper opening coupled to the bulk bin and a lower opening, wherein the lower opening has a larger cross-sectional area than the upper opening.

A 10^{th} embodiment is any combination of the first 9 embodiments, further comprises a second set of one or more vibration elements on the bulk bin.

An 11^{th} embodiment is any combination of the first 10 embodiments, wherein the bulk bin comprises one or more rotors disposed within an interior of the bulk bin for conveying the clusters nanoparticles through the bulk bin.

A 12^{th} embodiment is any combination of the first 11 embodiments, further comprising an elevator coupled to the collection vessel for elevating the clusters of nanoparticles from a first height of the container to a second height greater than the first height.

A 13^{th} embodiment is any combination of the first 12 embodiments, further comprising a feeder for advancing a substrate comprising fibers from an upstream end to a downstream end.

A 14^{th} embodiment is any combination of the first 13 embodiments, further comprising a dispersal system disposed between the elevator and the feeder, wherein, the dispersal system comprises a nozzle for dispersing the nanoparticles onto a first surface of a substrate comprising the fibers such that the nanoparticles penetrate through at least the first surface of the substrate.

A 15^{th} embodiment is any combination of the first 14 embodiments, further comprising a fiberization device configured to separate individual nanoparticles from the clusters of nanofibers.

A 16^{th} embodiment is any combination of the first 15 embodiments, further comprising a coating device for dispersing a binding agent onto the fibers in the substrate.

A 17^{th} embodiment is any combination of the first 16 embodiments, further comprising a dryer disposed near the feeder between the housing and the downstream end of the feeder for heating the nanoparticles and the fibers.

An 18^{th} embodiment is any combination of the first 17 embodiments, wherein the individual nanoparticles spaced apart from each other and have at least one dimension less than 1 micron.

In another aspect, a filter media is provided that is manufactured from any combination of the first 18 embodiments.

In another aspect, a filter is provided that is manufactured from any combination of the first 18 embodiments.

In another aspect, a first embodiment comprises a feed system for conveying nanoparticles. The system comprises a container for receiving clusters of nanoparticles, one or more components for converting each cluster of nanoparticles into a group of nanoparticles having a smaller mass or volume than the cluster of nanoparticles, a conveyor for advancing the group of nanoparticles and one or more vibration elements for pulsing the nanoparticles.

A second embodiment is the first embodiment, wherein the feed system is configured to convey the groups of nanoparticles at a controlled volumetric flow rate.

A 3^{rd} embodiment is any combination of the first 2 embodiments, wherein the container comprises a bulk bin comprising one or more rotors therein, wherein each rotor comprises one or more rotating blades for mechanically separating each cluster of nanoparticles into the group of nanoparticles.

A 4^{th} embodiment is any combination of the first 3 embodiments, wherein the rotors convey the groups of nanoparticles through the bulk bin.

A 5^{th} embodiment is any combination of the first 4 embodiments, wherein the rotors are configured to rotate about an axis transverse to a height of the container.

A 6^{th} embodiment is any combination of the first 5 embodiments, wherein at least some of the rotors rotate in a clockwise direction and at least some of the rotors rotate in a counterclockwise direction.

A 7^{th} embodiment is any combination of the first 6 embodiments, further comprising a collection vessel coupled to the bulk bin, wherein the one or more vibration elements are disposed on the outer walls of the collection vessel.

An 8^{th} embodiment is any combination of the first 7 embodiments, wherein the collection vessel has an upper opening coupled to the bulk bin and a lower opening, wherein the lower opening has a larger cross-sectional area than the upper opening.

A 9^{th} embodiment is any combination of the first 8 embodiments, further comprising a power source coupled to the vibration elements.

A 10^{th} embodiment is any combination of the first 9 embodiments, wherein the power source comprises an electric motor.

An 11^{th} embodiment is any combination of the first 10 embodiments, wherein the vibration elements are coupled to a source of compressed air.

A 12^{th} embodiment is any combination of the first 11 embodiments, wherein the conveyor comprises an elevator for conveying the clusters of nanoparticles from a first height of the collection vessel to a second height greater than the first height.

A 13^{th} embodiment is any combination of the first 12 embodiments, wherein the elevator comprises a tube having a plurality of discs configured to move through the tube, wherein each of the discs has an outer diameter less than an inner diameter of the tube.

A 14^{th} embodiment is any combination of the first 13 embodiments, wherein the discs define compartments therebetween for housing and conveying the nanoparticles.

A 15^{th} embodiment is any combination of the first 14 embodiments, wherein the discs are movable within the tube between the first and second heights.

A 16^{th} embodiment is any combination of the first 15 embodiments, wherein the feed system further comprises a feed bin coupled to the elevator at the second height.

A 17^{th} embodiment is any combination of the first 16 embodiments, wherein the feed bin comprises one or more rotating elements for conveying the groups of nanoparticles through the feed bin to the dispersion device.

An 18^{th} embodiment is any combination of the first 17 embodiments, wherein the feed bin comprises an auger comprising one or more curved bladed for redirecting the groups of nanoparticles.

A 19^{th} embodiment is any combination of the first 18 embodiments, wherein the feed bin comprises one or more vibration elements for conveying the clusters of nanoparticles through the feed bin to the dispersion device.

In another aspect, a filter media is provided that is formed from any combination of the above 19 embodiments.

In another aspect, a gas or liquid filter is provided that is formed from any combination of the above 19 embodiments.

In another aspect, a first embodiment is a filter media formed from a process comprising: delivering clusters of nanoparticles into a container; vibrating the container to convey the clusters of nanoparticles through the container; and combining the nanoparticles with fibers to form the filter media.

A second embodiment is the first embodiment further comprising vibrating outer walls of the container to separate the clusters of nanoparticles from said outer walls.

A third embodiment is any combination of the first two embodiments, further comprising delivering the clusters of nanoparticles into a bulk bin and conveying the clusters of nanoparticles through the bulk bin with one or more rotors.

A 4^{th} embodiment is any combination of the first 3 embodiments, further comprising elevating the clusters of nanoparticles from a first height of the container to a second height greater than the first height.

A 5^{th} embodiment is any combination of the first 4 embodiments, further comprising: advancing a substrate comprising fibers from an upstream end to a downstream end; and dispersing the nanoparticles onto a first surface of a substrate comprising the fibers such that the nanoparticles penetrate through at least the first surface of the substrate.

What is claimed is:

1. A system for manufacturing a filter media, the system comprising:
a container for receiving clusters of nanoparticles;
one or more vibration elements coupled to the container and configured to pulse the clusters of nanoparticles to convey the clusters of nanoparticles through the container; and
an apparatus coupled to the container for receiving the nanoparticles, the apparatus comprising one or more components for combining the nanoparticles with fibers to form the filter media.

2. The system of claim 1, wherein the one or more vibration elements are configured to vibrate outer walls of the container to separate the nanoparticles from outer walls of the container.

3. The system of claim 1, wherein the one or more vibration elements are disposed within the interior of the container.

4. The system of claim 1, further comprising a power source coupled to the vibration elements.

5. The system of claim 4, wherein the power source comprises an electric motor.

6. The system of claim 1, wherein the vibration elements are coupled to a source of compressed air.

7. The system of claim 1, further comprising a bulk bin for receiving the clusters of nanoparticles and a collection vessel coupled to the bulk bin, wherein the vibration elements are disposed on the collection vessel and wherein the collection vessel has an upper opening coupled to the bulk bin and a lower opening, wherein the lower opening has a larger cross-sectional area than the upper opening.

8. The system of claim 7, further comprises a second set of one or more vibration elements on the bulk bin.

9. The system of claim 7, wherein the bulk bin comprises one or more rotors disposed within an interior of the bulk bin for conveying the clusters nanoparticles through the bulk bin.

10. The system of claim 7, further comprising an elevator coupled to the collection vessel for elevating the clusters of nanoparticles from a first height of the container to a second height greater than the first height.

11. The system of claim 1 further comprising a feeder for advancing a substrate comprising fibers from an upstream end to a downstream end and a dispersal system disposed between the elevator and the feeder, wherein the dispersal system comprises a nozzle for dispersing the nanoparticles onto a first surface of a substrate comprising the fibers such that the nanoparticles penetrate through at least the first surface of the substrate.

12. A filter formed by the system of claim 1.

13. A feed system for conveying nanoparticles, the system comprising:
a container for receiving clusters of nanoparticles;
one or more components for converting each cluster of nanoparticles into a group of nanoparticles having a smaller mass or volume than the cluster of nanoparticles;
a conveyor for advancing the group of nanoparticles; and
one or more vibration elements for pulsing the nanoparticles.

14. The system of claim 13, wherein the feed system is configured to convey the groups of nanoparticles at a controlled volumetric flow rate.

15. The system of claim 13, wherein the container comprises a bulk bin comprising one or more rotors therein, wherein each rotor comprises one or more rotating blades for mechanically separating each cluster of nanoparticles into the group of nanoparticles.

16. The system of claim 15, wherein the rotors convey the groups of nanoparticles through the bulk bin.

17. The system of claim 15, wherein the rotors are configured to rotate about an axis transverse to a height of the container.

18. The system of claim 15, wherein at least some of the rotors rotate in a clockwise direction and at least some of the rotors rotate in a counterclockwise direction.

19. The system of claim 13, further comprising a collection vessel coupled to the bulk bin, wherein the one or more vibration elements are disposed on the outer walls of the collection vessel, wherein the collection vessel has an upper opening coupled to the bulk bin and a lower opening, wherein the lower opening has a larger cross-sectional area than the upper opening.

20. The system of claim 13, wherein the conveyor comprises an elevator for conveying the clusters of nanoparticles from a first height of the collection vessel to a second height greater than the first height.

21. The system of claim 20, wherein the elevator comprises a tube having a plurality of discs configured to move through the tube, wherein each of the discs has an outer diameter less than an inner diameter of the tube.

22. The system of 20, wherein the feed system further comprises a feed bin coupled to the elevator at the second height, wherein the feed bin comprises one or more rotating elements for conveying the groups of nanoparticles through the feed bin to the dispersion device.

23. The system of claim 20, wherein the feed bin comprises an auger comprising one or more curved blades for redirecting the groups of nanoparticles.
